(19) United States
(12) Patent Application Publication
(10) Pub. No.: US 2026/0260136 A1
(43) Pub. Date: Sep. 3, 2026

(54) INFERENCE DATA SIMILARITY FEEDBACK FOR MACHINE LEARNING MODEL PERFORMANCE MONITORING IN BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 19/158,026

(22) PCT Filed: Apr. 7, 2023
(86) PCT No.: PCT/CN2023/086866

§ 371 Date: Aug. 19, 2025

(51) Int. Cl. G06N 5/04; G06F 18/22; H04W 16/28; H04W 72/231

(52) U.S. Cl. CPC G06N 5/04; G06F 18/22; H04W 16/28; H04W 72/231

(57) ABSTRACT

In an aspect, a UE may obtain a first indication of a first set of characteristics associated with a plurality of reference datasets. The UE may calculate a respective level of similarity between an inference dataset and each of the plurality of reference datasets based on the first set of characteristics and a second set of characteristics associated with the inference dataset. The UE may output at least one second indication of the respective level of similarity between the inference dataset and each of the plurality of reference datasets.

### TECHNICAL FIELD

The present disclosure relates generally to communication systems, and more particularly, to machine learning for predictive beam management.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include memory and at least one processor coupled to the memory. The at least one processor, based at least in part on information stored in the memory may be configured to obtain a first indication of a first set of characteristics associated with a plurality of reference datasets, to calculate a respective level of similarity between an inference dataset and each of the plurality of reference datasets based on the first set of characteristics and a second set of characteristics associated with the inference dataset, and to output at least one second indication of the respective level of similarity between the inference dataset and each of the plurality of reference datasets.

In another aspect of the disclosure, a method, a computer-readable medium, and an apparatus at a network entity are provided. The apparatus may include memory and at least one processor coupled to the memory. The at least one processor, based at least in part on information stored in the memory may be configured to receive at least one first indication of a respective level of similarity between an inference dataset and each of a plurality of reference datasets, where the respective level of similarity is based on a first set of characteristics associated with the plurality of reference datasets and a second set of characteristics associated with the inference dataset, and to provide a second indication to perform an action based on the respective level of similarity between the inference dataset and each of the plurality of reference datasets.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an AI/ML algorithm for wireless communication and that illustrates various aspects model training, model inference, model feedback, and model update.

FIG. 5 is a diagram illustrating inference dataset similarity level feedback in accordance with various aspects of the present disclosure.

FIG. 6 is a diagram illustrating a database block group in accordance with various aspects of the present disclosure.

FIG. 7 illustrates a diagram depicting different quantization granularities in accordance with various aspects of the present disclosure.

FIG. 8 is a call flow diagram illustrating a method of wireless communication in accordance with various aspects of the present disclosure.

FIG. 9 is a flowchart illustrating methods of wireless communication in accordance with various aspects of the present disclosure.

FIG. 10 is a flowchart illustrating methods of wireless communication in accordance with various aspects of the present disclosure.

FIG. 11 is a flowchart illustrating methods of wireless communication in accordance with various aspects of the present disclosure.

FIG. 12 is a flowchart illustrating methods of wireless communication in accordance with various aspects of the present disclosure.

FIG. 13 is a diagram illustrating an example of a hardware implementation for an example apparatus and/or network entity.

FIG. 14 is a diagram illustrating an example of a hardware implementation for an example network entity.

FIG. 15 is a diagram illustrating an example of a hardware implementation for an example network entity.

### DETAILED DESCRIPTION

Various aspects of the present disclosure, in connection with the accompanying drawings, relate generally to communication systems. Some aspects more specifically relate to machine learning for predictive beam management. In some examples, a UE may receive obtain an indication of first set of characteristics associated with a plurality of reference datasets. The plurality of reference datasets may be utilized to train a machine learning mode (e.g., at a network entity). The UE may calculate a respective level of similarity between an inference dataset and each of the plurality of reference datasets based on the first set of characteristics and a second set of characteristics associated with the inference dataset. The inference dataset may be utilized at the UE to perform model inference via machine learning model (e.g., to perform beam prediction). For each respective reference dataset of the plurality of reference datasets, the UE may output a respective indication of the respective level of similarity between the inference dataset and the respective reference dataset. The respective indications may be provided to a network entity. The network entity may determine an action to be performed at the UE based on the respective indications. Such actions include, but are not limited to, suspending the machine learning model utilized at the UE or switching to a different machine learning model.

Particular aspects of the subject matter described in this disclosure can be implemented to realize one or more of the following potential advantages. In some examples, by outputting respective indications of respective levels of similarity between the inference dataset and the plurality of reference datasets, the network entity may determine the effectiveness of the machine learning model utilized at the UE with respect to the environment in which the UE is located. In the event that the network node determines that the machine learning model utilized at the UE is relatively ineffective based on the respective levels of similarity, the network entity may cause the UE to utilize a different machine learning model that is tailored to the environment in which the UE is located. Such a machine learning model may more accurately predict an optimal transmit beam for transmitting signals and/or an optimal receive beam for receiving signals. Accordingly, the aspects of the subject matter described in this disclosure may improve the signal-to-noise ratio of received signals, eliminate undesirable interference sources, and focus transmitted signals to desired locations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

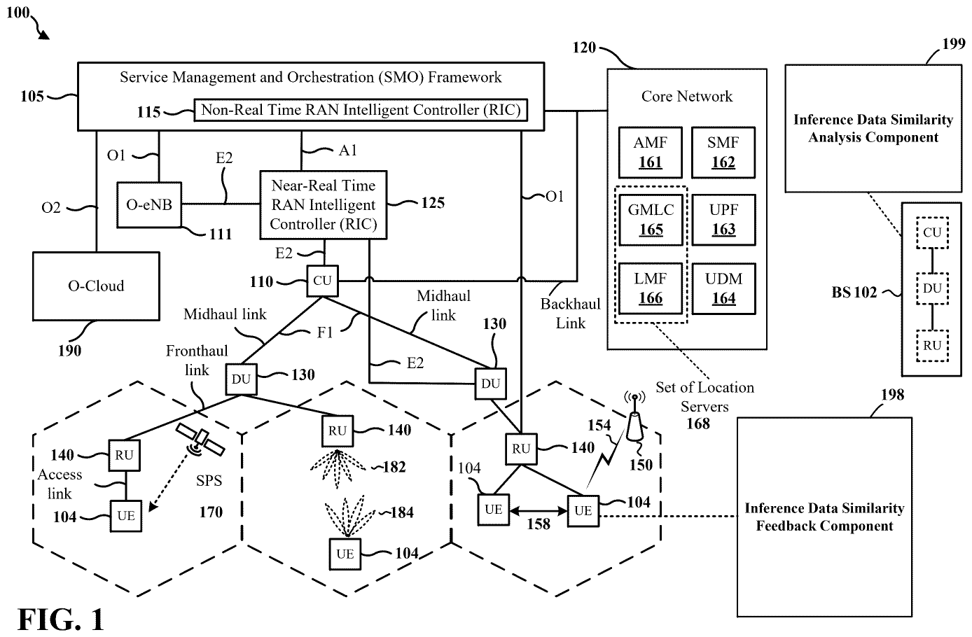

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface).

For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an inference data similarity feedback component 198 that may be configured to obtain a first indication of a first set of characteristics associated with a plurality of reference datasets, to calculate a respective level of similarity between an inference dataset and each of the plurality of reference datasets based on the first set of characteristics and a second set of characteristics associated with the inference dataset, and to output at least one second indication of the respective level of similarity between the inference dataset and each of the plurality of reference datasets. In certain aspects, the base station 102 may have an inference data similarity analysis component 199 that may be configured to receive at least one first indication of a respective level of similarity between an inference dataset and each of a plurality of reference datasets, where the respective level of similarity is based on a first set of characteristics associated with the plurality of reference datasets and a second set of characteristics associated with the inference dataset, and to provide a second indication to perform an action based on the respective level of similarity between the inference dataset and each of the plurality of reference datasets.

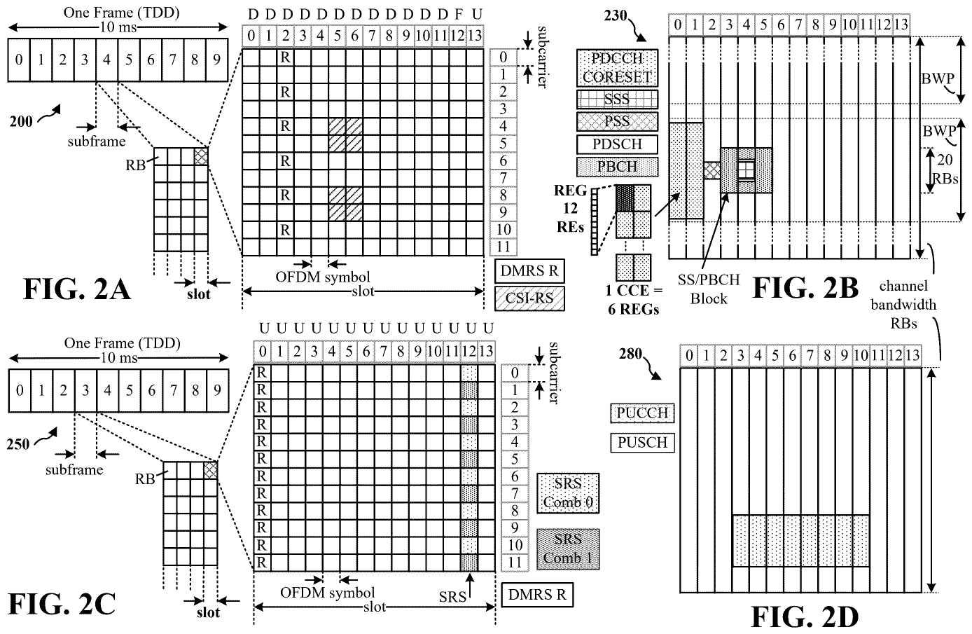

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), (or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

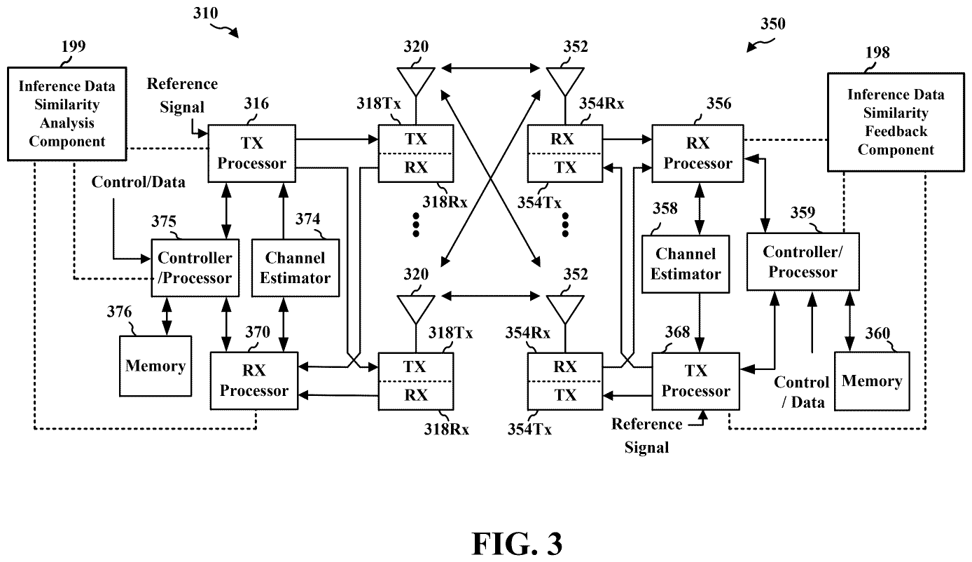

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the inference data similarity feedback component 198 of FIG. 1.

At least one of the TX processor 316, the RX processor 370, and the controller/processor 375 may be configured to perform aspects in connection with the inference data similarity analysis component 199 of FIG. 1.

UEs and networks may perform various aspects of beam management in order to select a beam for transmission and reception. In some aspects, beam management may be performed using a tracking reference signal (TRS), e.g., for a UE in an RRC inactive or RRC idle state. For initial access, a UE may use an SSB, e.g., with a wide beam sweeping procedure to identify a beam to use for initial access. For contention-based random access (CBRA), a UE may use a random access occasion (RO) and a preamble that corresponds to the selected SSB/beam. In an RRC connected state, the UE and/or network may perform various aspects of beam management, e.g., including a P1, P2, and P3 procedure using SSB or CSI-RS measurements; a U1, U2, and U3 procedure using SRS transmissions and measurement, layer 1 (L1)-reference signal received power (RSRP) reporting. The network may configure one or more TCI state configurations for the UE, and may indicate a TCI state for the UE from the configured set of TCI states. In some aspects, the UE may provide L1-signal-to-interference-plus-noise ratio (SINR) reporting, which may reduce overhead and latency and allow for CC group beam updates or faster UL beam updates. In some aspects, the UE may communicate with the network using unified TCI states, L1/layer 2 (L2) centric mobility (which may also be referred to a L1/L2 triggered mobility (LTM)), dynamic TCI updates, and/or uplink multi-panel selection, maximum permissible exposure (MPE) migration, further beam management latency reduction, etc. Beam management may be employed for particular scenarios, such as high speed (e.g., high speed train (HST)), single frequency network (SFN), multiple transmission reception points (mTRP), among other examples. Based on measurements, a UE may perform a beam failure detection (BFD) process and may perform a beam failure recovery (BFR) process. In some aspects, the BFD or BFR may be for a primary cell (PCell) or a primary secondary cell (PSCell). BFD may be based on a BFD reference signal (BFD-RS) and a PDCCH block error rate (BLER). The BFR may be based on a contention free random access (CFRA). For an SCell, the BFD and BFR may include a link recovery request via a scheduling request (SR), or a MAC-CE based BFR for the SCell. If the BFR is unsuccessful, the UE may identify a radio link failure.

Some wireless communication may include the use of AI or ML at the network and/or at the UE. Among various examples, AI/ML may be used for beam management at a UE and/or a network, including for performing beam predictions in a time domain and/or spatial domain. The use of an AI/ML model may reduce latency or overhead and may improve the accuracy of beam selection. Models may be provided that support various levels of network and UE collaboration and to support various use cases. The use of an AI/ML model may include various aspects such as model training, model deployment, model inference, model monitoring, and model updating.

For AI/ML-based beam management, different beam management cases may be supported for characterization and baseline performance evaluations. For example, in one beam management case (BM-Case1), spatial-domain downlink beam prediction for a first set of beams (Set A) may be based on measurement results of a second set of beams (Set B). In another beam management case (BM-Case2), temporal downlink beam prediction for Set A may be based on the historic measurement results of Set B. For both BM-Case1 and BM-Case2, the beams in Set A and Set B may be in the same frequency range. In some aspects, for BM-Case1, Set B may be a subset of Set A. In other aspects, Set A and Set B may be different (e.g., Set A includes narrow beams and Set B includes wide beams). In further aspects, Set A may be for downlink beam prediction and Set B may be for downlink beam measurement.

In an aspect in which an AI/ML model may be utilized at the UE for BM-Case1, L1 signaling maybe utilized to report various information of AI/ML model inference to the network. Such information may include, the beam(s) that are based on the output of AI/ML model inference, the predicted L1-RSRP corresponding to the beam(s), etc. In an aspect in which an AI/ML model may be utilized at the UE for BM-Case2, L1 signaling maybe utilized to report various information of AI/ML model inference to the network. Such information may include the beam(s) of N future time instance(s) that are based on the output of the AI/ML model, where N is any positive integer, the predicted L1-RSRP corresponding to the beam(s), information about the timestamp corresponding to the reported beam(s), etc. In aspects in which an AI/ML model may be utilized at the UE for both BM-Case1 and BM-Case2, UE-side model monitoring, network side model monitoring, or hybrid model monitoring may be utilized. For UE-side model monitoring, the UE may monitor the performance metric(s) and make decision(s) pertaining to model selection, activation, deactivation, switching, or fallback operation(s). For network-side model monitoring, the network may monitor the performance metric(s) and make decision(s) pertaining to model selection, activation, deactivation, switching, or fallback operation(s). For hybrid model monitoring, the UE may monitor the performance metric(s) and the network may make decision(s) pertaining to model selection, activation, deactivation, switching, or fallback operation(s), or vice versa. In aspects in which an AI/ML model may be utilized at the network for both BM-Case1 and BM-Case2, the network may monitor the performance metric(s) and make decision(s) pertaining to model selection, activation, deactivation, switching, or fallback operation(s). In such aspects, beam measurements and reporting may also be performed for model monitoring and/or the UE may report the measurement results of more than four beams in one reporting instance.

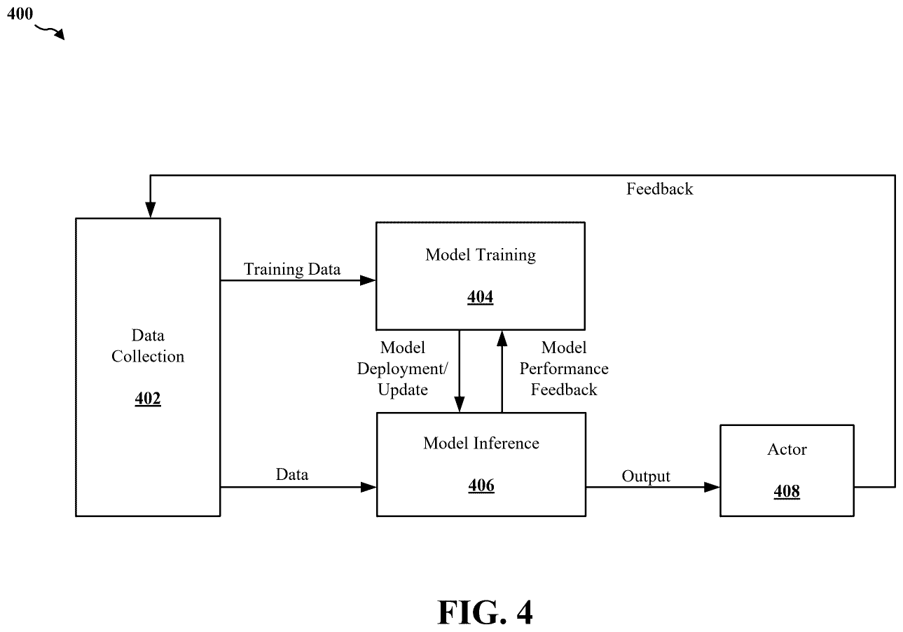

FIG. 4 is a diagram 400 illustrating an AI/ML algorithm for wireless communication and that illustrates various aspects model training, model inference, model feedback, and model update. The AI/ML algorithm may include various functions including a data collection function 402, a model training function 404, a model inference function 406, and an actor function 408. Various aspects described in connection with FIG. 4 may be performed by one or more entities in a wireless communication system. As an example, in some aspects, the data collection, model training, model inference, and action based on the model inference may occur at a UE. In other aspects, the data collection, model training, model inference, and action based on the model inference may occur at the network. In other aspects, the data collection may occur at the UE and may be provided to the network, which performs the model training and/or model inference. In some aspects, the output may be used at the network or may be provided to a UE, which may perform an action based on the output. In other aspects, the data collection may be performed at the network and may be provided to a UE, which may perform the model training and/or model inference. In some aspects, the UE may use the output to perform an action or may provide the output to the network. These are non-limiting examples to illustrate the concept that one or more of the functions described in connection with FIG. 4 may be performed by a UE and/or a network node.

The data collection function 402 may be a function that provides input data to the model training function 404 and the model inference function 406. The data collection function 402 may include any form of data preparation, and it may not be specific to the implementation of the AI/ML algorithm (e.g., data pre-processing and cleaning, formatting, and transformation).

Examples of input data may include, but are not limited to, measurements, such as RSRP measurements, channel measurements, or other uplink/downlink transmissions, from entities including UEs or network nodes, feedback from the actor function 408 (e.g., which may be a UE or network node), output from another AI/ML model, etc. The data collection function 402 may include training data, which refers to the data to be sent as the input for the model training function 404, and inference data, which refers to the data to be sent as the input for the model inference function 406.

The model training function 404 may be a function that performs the ML model training, validation, and testing, which may generate model performance metrics as part of the model testing procedure. The model training function 404 may also be responsible for data preparation (e.g., data pre-processing and cleaning, formatting, and transformation) based on the training data delivered or received from the data collection function 402. The model training function 404 may deploy or update a trained, validated, and tested AI/ML model to the model inference function 406, and receive a model performance feedback from the model inference function 406. As described above, there may be various functionalities to be performed by an AI/ML model for wireless communication.

The model inference function 406 may be a function that provides an AI/ML model inference output (e.g., predictions or decisions). The model inference function 406 may also perform data preparation (e.g., data pre-processing and cleaning, formatting, and transformation) based on the inference data delivered from the data collection function 402. The output of the model inference function 406 may include the inference output of the AI/ML model produced by the model inference function 406. The details of the inference output may be use case specific. As an example, the output may include a beam prediction for beam management. The prediction may be for the network or may be for the UE. In some aspects, the actor function 408 may be a component of the base station or of a core network. In other aspects, the actor function 408 may be a UE in communication with a wireless network.

The model performance feedback may refer to information derived from the model inference function 406 that may be suitable for the improvement of the AI/ML model trained in the model training function 404. The feedback from the actor function 408 or other network entities (via the data collection function 402) may be implemented for the model inference function 406 to create the model performance feedback.

The actor function 408 may be a function that receives the output from the model inference function 406 and triggers or performs corresponding actions. The actor function 408 may trigger actions directed to network entities including the other network entities or itself. The actor function 408 may also provide feedback information that the model training function 404 or the model inference function 406 to derive training or inference data or performance feedback. The feedback may be transmitted back to the data collection function 402.

The network and/or a UE may use machine-learning algorithms, deep-learning algorithms, neural networks, reinforcement learning, regression, boosting, or advanced signal processing methods for aspects of wireless communication including the various functionalities such as beam management, CSF, or positioning, among other examples.

In some aspects described herein, the network and/or a UE may train one or more neural networks to learn the dependence of measured qualities on individual parameters. Among others, examples of machine learning models or neural networks that may be included in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by the concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., any feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processing for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from an input at a first layer through the multiple layers of the neural network to an output at the last layer of the neural network and may traverse layers multiple times.

In some aspects, there may network pre-trained machine learning model and data mismatch during inference. One AI/ML beam prediction deployment scheme may be to train AI/ML models by a network or a third party, and enable a UE to download such models for their local inference. However, in practice, inference data may be mismatched with training data in many corner cases, which may degrade ML performance. In some aspects, auxiliary reference signals may be scheduled to verify and report the prediction accuracy. However, scheduling auxiliary reference signals (along with having the UE compare measurements vs. predictions and report the comparison results) all the time may not be practical, as such a technique falls back to pure measurements. On the other hand, occasionally monitoring/reporting such comparisons may not give a full picture on the AI/ML performance.

In accordance with various aspects of the present disclosure, one solution is to configure a UE to feedback similarity levels between the inference dataset (e.g., at least the data used as AI/ML input for model inference) and a plurality of reference datasets (e.g., which may be used for training different machine learning models). That is, the UE may measure the similarity (or difference) between the inference dataset and reference training dataset to address the issue of training data mismatch with inference dataset. Such techniques may enable more accurate tracking of the inference dataset, may identify potential ML performance degradation, and may also enable more efficient ML model switching (e.g., than compared to the auxiliary RS methods described above). The foregoing may be performed efficiently, for example, by reporting similarity metrics between training datasets and the inference dataset. The similarity metrics may be preconfigured or predefined (e.g., defined in a wireless standard, predetermined, configured by the network for the UE, preconfigured in advance of being indicated, etc.), or alternatively, may be defined, controlled, and/or signaled by the network (e.g., a network node or a component of the core network). The characteristics of the training datasets may be indicated by the network, while the characteristics of the inference dataset may be measured by the UE (e.g., with low complexity (e.g., based on statistics of the characteristics, such as a maximum, a minimum, a mean, a variance, a standard deviation, a probability density function (PDF), a cumulative distribution function (CDF), etc.)). The similarity levels between training datasets and the inference dataset may be further reported by the UE to enable the network to decide whether to terminate or suspend (e.g., cause the termination or suspension of) AI/ML at the UE, or whether the UE is to switch to a utilization of a different machine learning model or utilize alternate methods for inference.

To better enable the identification of a machine learning model switch, the UE may be indicated with characteristics with respect to multiple reference training datasets and may feedback the associated similarity levels respectively. Depending on how quickly the UE feedback is needed, a grouping of certain training datasets may be utilized to further reduce the UE feedback overhead. The scheme utilized for grouping may be preconfigured or predefined, controlled and/or signaled by the network, or may be determined and/or recommended by the UE.

In accordance with various aspects of the present disclosure, a UE may provide inference data similarity level feedback with respect to reference training datasets. In some aspects, a UE may report to the network, on similarity levels, between characteristics of UE local observations and a number (e.g., a plurality) of reference (training) datasets. The UE local observations may be associated with at least AI/ML-based channel characteristics identification (e.g., beam prediction). The reference training datasets to be addressed in a certain UE report may be predefined or preconfigured, may be controlled and/or signaled by the network, or may be reported (e.g., determined and/or recommended) by the UE. The UE local observations may include UE local measurements that may be used as AI/ML input for such channel characteristics identification tasks and/or include other UE local measurements (e.g., Doppler associated with the UE, delay spread associated with the UE, speed of the UE, rotation of the UE, etc.). The similarity levels may be defined as similarity metric(s) (which may be preconfigured or predetermined, may be controlled and/or signaled by the network, or may be determined and/or recommended by the UE) between characteristics of the UE local observations (e.g., the inference dataset) and characteristics regarding the reference training datasets. The characteristics of the training datasets may be separately indicated by the network to the UE. In some aspects, the UE may provide signaling carrying the data similarity-level feedback via one or more of RRC-based signaling, medium access control (MAC)-control element (MAC-CE)-based signaling, or UCI. MAC-CE-based signaling and/or UCI may be utilized for cases where the AI/ML model is utilized to predict layer 1 (L1) channel characteristics. In other aspects, the UE may utilize application layer protocols (e.g., that are transparent to 3GPP-based protocols). However, the utilization of such protocols may be less efficient for cases where the AI/ML model is utilized to predict L1 channel characteristics.

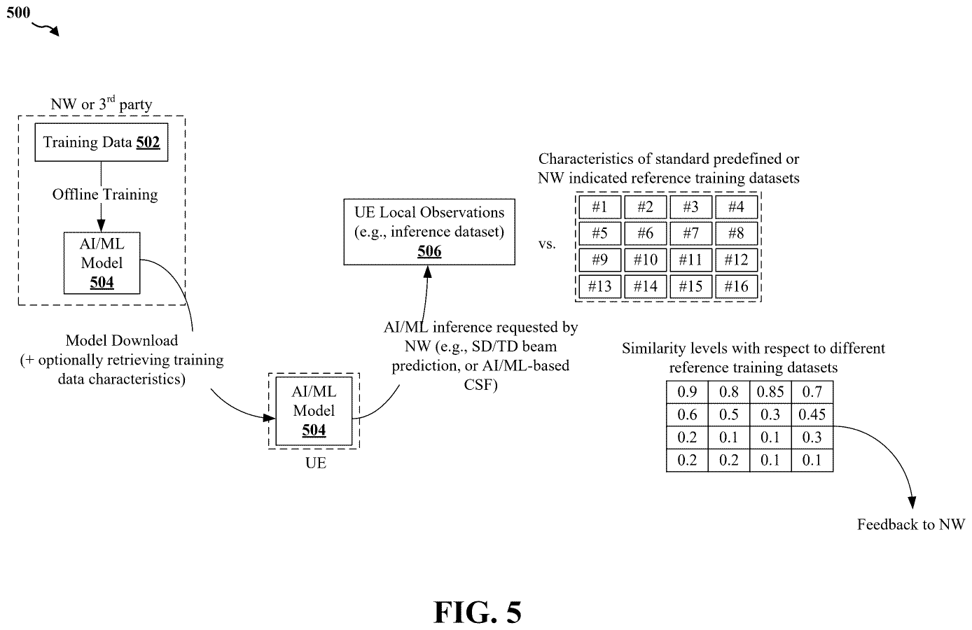

FIG. 5 is a diagram 500 illustrating inference dataset similarity level feedback in accordance with various aspects of the present disclosure. As shown in FIG. 5, training data (e.g., reference training dataset(s)) 502 may be utilized by the network or a third party to train an AI/ML model 504. A UE may download the AI/ML model 504 from the network or third party. The UE may also download characteristics of the training data 502 from the network or third party. The network may request the UE to perform an inference utilizing the AI/ML model 504. The inference may be for spatial domain (SD)/time domain (TD) beam prediction, AI/ML-based channel state feedback (CSF), etc. The UE may obtain local observations 506, which may collectively be utilized as an inference dataset that is input into the AI/ML model 504 for inference. The UE may compare the characteristics of the local observations 506 to the characteristics of each of the reference training datasets to determine a respective level of similarity between the local observations 506 and each of the reference training datasets. The UE may provide each of the respective levels of similarity to the network. As shown in FIG. 5, each of the similarity levels may be a value ranging between 0.0 and 1.0, where higher the value, the greater the similarity between the local observations 506 and a respective reference training dataset. It is not that in certain embodiments, the similarity values may be represented using different values.

In some aspects, training datasets may be grouped based on TD occasions. For example, within a certain group (referred herein as a dataset block group (DBG)) of reference training datasets (e.g., which may be predetermined or preconfigured or may be controlled and/or signaled by the network), a certain subset (e.g., a first, second, or third subset) of frequency domain (FD)/TD occasions may be identified as a corresponding sub-group (e.g., a first, second, or third sub-group). A sub-group may be referred herein as a dataset block (DB), which includes a particular subset of FD/TD occasions associated with the reference training datasets. The criteria utilized to carry out such segmentation (or grouping) within a certain DBG may be predetermined or preconfigured, or alternatively, may be based on use-case/feature/scenario. Certain segmentation criteria may also be dynamically varied by a network node, for example, through MAC-CE-based signaling or DCI. For example, suppose a predefined or preconfigured training dataset may include a delay spread that varies from 10 nanoseconds (ns) to 1000 ns in a 10 ns step size. Further suppose that the dataset is based on beam widths that vary from 3 degrees to 30 degrees regarding 8 different beams in a 1-degree step size. In certain scenarios, there may be a limitation on the similarly level feedback overhead and/or the UE may need to feedback such similarity levels too frequently. To mitigate such limitations, such datasets may be further sub-grouped based on a coarser delay spread step size and/or a beam width step size. Such grouping criteria may be indicated by the network.

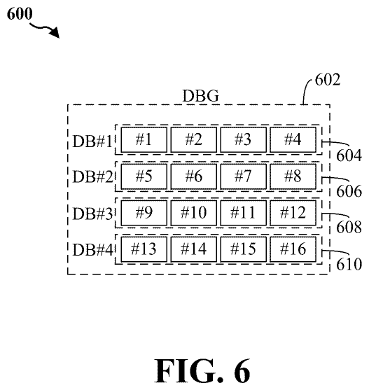

Each similarity level UE feedback may be associated with a single DBG, where the respective DBs within the DBG may be reported with separate similarity levels. That is, each time the UE provides similarity level feedback, the feedback may be for the DBs of a particular DBG. For example, FIG. 6 is a diagram 600 illustrating a DBG 602 in accordance with various aspects of the present disclosure. As shown in FIG. 6, the DBG 602 may include a first DB 604, a second DB 606, a third DB 608, and a fourth DB 610, each of which being associated with four different training datasets. The UE may report a level of similarity for each of the training datasets within a particular DB.

In some aspects, techniques for identifying the characteristics of a certain DB based on the training datasets included in the DB may be preconfigured or predetermined or may be controlled and/or signaled by the network. For example, a preconfigured or predetermined technique may indicate that the resulting delay spread/beam width for a DB is to be based on the average delay spreads/beam widths of the respective datasets involved. Another technique may be for the UE to group the training datasets into a particular DB based on the local observations made at the UE.

In some aspects, the similarly level feedback may be quantized based on the granularity of the feedback. In some aspects, the number of bits to characterize similarity levels in a similarity level report may be preconfigured or predefined, controlled and/or signaled by the network, or may be determined and/or recommended by a UE. Different similarly level quantization granularities may be used for different use cases/features/scenarios. Such quantization granularities may also be preconfigured or predefined, controlled and/or signaled by the network, or may be determined and/or recommended by a UE. In some aspects, the similarity level feedback may be based on variable quantization granularity depending on the total number of DBs addressed in a single DBG for a single similarity level report (e.g., the total number of bits may be fixed, while the quantization granularity may be varied according to the fixed overall payload and the number of DBs).

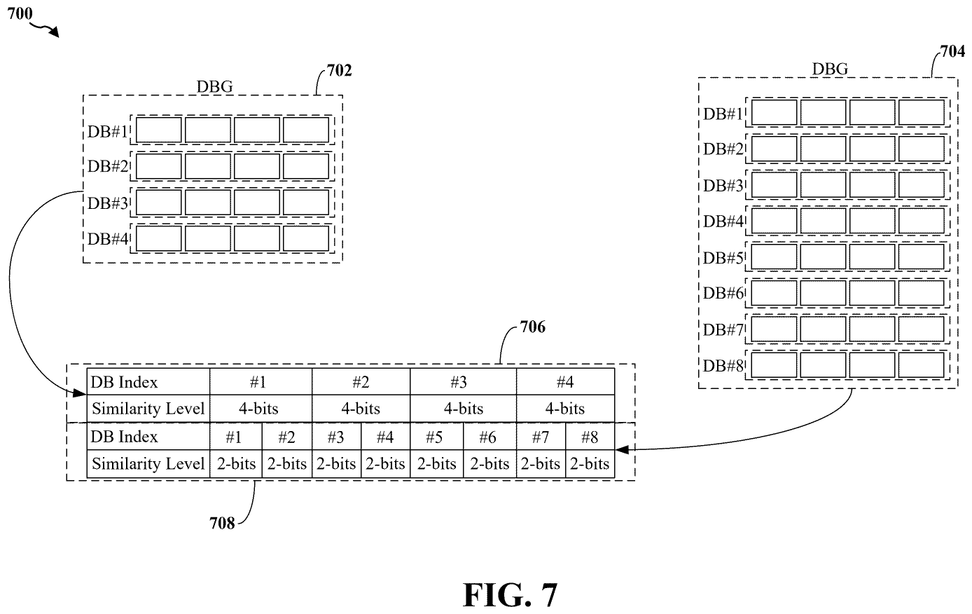

For example, FIG. 7 illustrates a diagram 700 depicting different quantization granularities in accordance with various aspects of the present disclosure. As shown in FIG. 7, a first DBG 702 includes four DBs. Accordingly, in a first similarity level report 706, a DB index may be specified for each of the four DBs, and four bits may be utilized for the similarity level for each of the DBs. As also shown in FIG. 7, a second DBG 704 may include eight DBs. Accordingly, in a second similarity level report 708, a DB index may be specified for each of the eight DBs, and two bits may be utilized for the similarity level for each of the DBs.

Each of the reference training datasets and/or the local observations (e.g., the inference dataset) may be associated with various characteristics. The characteristics may include general characteristics and characteristics pertaining to beam prediction AI/ML models. Examples of general characteristics include, but are not limited to, operation scenarios or an environment in which the UE is located (e.g., a dense urban environment, an indoor environment, a rural environment, etc.), channel profiles (e.g., the range of delay spread or Doppler of a channel via which the UE communications, one or more parameters of the network node/cell (e.g., the size/type/orientation of the network node antenna arrays, the number of beams in the codebook, the transmit power of the network node, the capabilities of the UE, etc.), the location of the UE (e.g., whether the UE is relatively close or far away from the network node), etc. Examples of characteristics pertaining to beam prediction AI/ML models include, but are not limited to, a distribution (e.g., a maximum, a minimum, a mean, a variance, a standard deviation, a probability density function (PDF), a cumulative distribution function (CDF)) of one or more measured/reported signal metrics (e.g., L1-RSRPs, L1-SINRs, etc.) to be utilized as AI/ML model inputs for model inference, UE mobility characteristics (e.g., moving direction/speed, rotation direction/speed, orientation), UE-estimated angle of arrival and/or angle of departure of network node beams as measurement resources or AI/ML inputs for model inference, transmit beam shapes (e.g., ranges of beam pointing directions (or directions that a beam may point) or beam widths of measurement resources or prediction targets), receive beam shapes (e.g., ranges of beam pointing directions (or directions that a beam may point) or beam widths to measure the signal metrics (e.g., L1-RSRPs/L1-SINRs), etc.

In some aspects, the UE may report various capabilities thereof. For example, the UE may report whether it supports data similarity level feedback. The UE may report the maximum number of TD occasions that it can track for a single DB or DBG. The UE may report the maximum number of DBs it supports per DBG. The UE may report how frequent it can report such similarity level feedback. Such reporting may be based on reporting different capabilities for different use cases/features/scenarios. For example, the UE may report that it supports data similarity feedback for L1-RSRP prediction including less than 8 measurement resources, but does not support data similarity feedback for L1-RSRP prediction including more than 8 measurement resources. In another example, when a AI/ML-based CSI feedback cycle is less than 10 milliseconds (ms) (i.e., the UE carries out AI/ML-based CSF less than every 10 ms), the associated maximum number of TD occasions that the UE can track for a single DB may be 100. However, when the AI/ML-based CSI feedback cycle is more than 10 ms (i.e., the UE carries out AI/ML-based CSF no less than every 10 ms), the associated maximum number of TD occasions that the UE can track for a single DB may be 250. Accordingly, the UE may report such maximum numbers of TD occasions based the length of the AI/ML-based CSI feedback cycle.

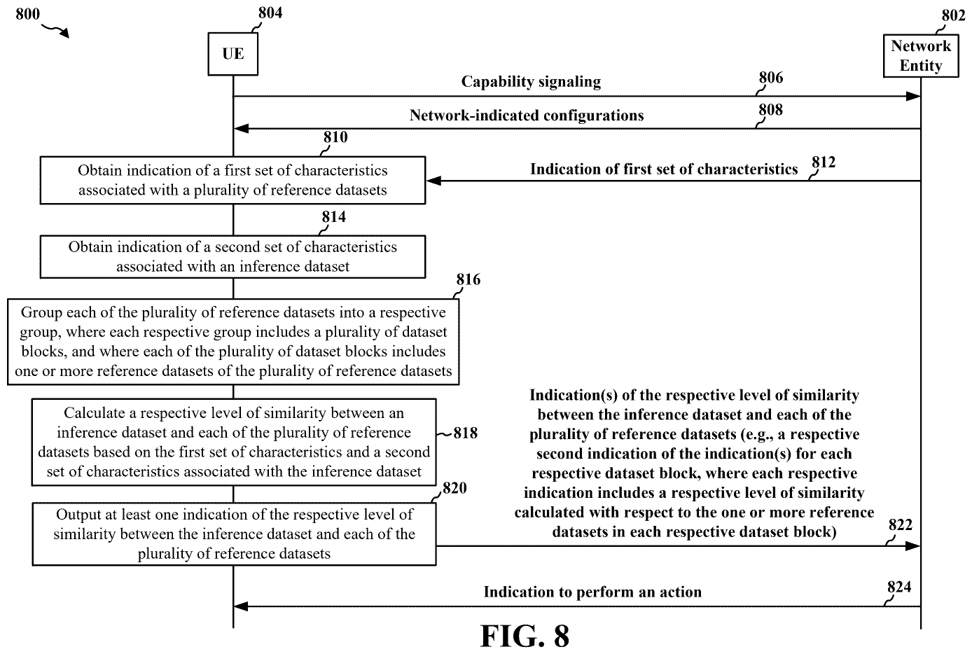

FIG. 8 is a call flow diagram 800 illustrating a method of wireless communication in accordance with various aspects of the present disclosure. As shown in FIG. 8, the diagram 800 includes a network entity 802 and a UE 804. The UE 804 may be an example of the UE 104 or the UE 350. The network entity 802 may be an example of the base station 102, the base station 310, or a component of the core network 120. Although aspects are described for the network entity 802, the aspects may be performed by the network entity 802 in aggregation and/or by one or more components of the network entity 802 (e.g., such as a CU 110, a DU 130, and/or an RU 140). As shown in FIG. 8, at 806, the UE 804 may provide capability signaling to the network entity 802, which may signal to the network entity 802 one or more capabilities (or functionality) supported by the UE 804. For example, the capability signaling may indicate whether the UE 804 supports data similarity level feedback, the maximum number of TD occasions that the UE 804 may track for a single DB or DBG, the maximum number of DBs supported per DBG, the frequency at which the UE 804 may report data similarly level feedback.

At 808, the network entity 802 may provide one or more network-indicated configurations to the UE 804 based on the capability signaling received at 806. For example, the network-indicated configurations may include similarity metric(s) between characteristics of the inference dataset utilized by the UE 804 and the characteristics of the reference datasets, grouping criteria utilized for grouping the reference datasets into a DBG, etc.

At 810, the UE 804 may obtain an indication of a first set of characteristics associated with a plurality of reference datasets. In some aspects, the UE 804 may receive the indication from the network entity 802, e.g., as shown at 812. In other aspects, the UE 804 may retrieve the indication from a memory of the UE 804.

At 814, the UE may obtain an indication of a second set of characteristics associated with an inference dataset. The second set of characteristics may be based on local observations made by the UE 804. The UE 804 may store the local observations in a memory of the UE 804 and retrieve the local observations from the memory when calculating the similarly levels between the inference dataset and the plurality of reference datasets.

In some aspects, the first set of characteristics and the second set of characteristics may include, but are not limited to, operation scenarios or an environment in which the UE is located (e.g., a dense urban environment, an indoor environment, a rural environment, etc.), channel profiles (e.g., the range of delay spread or Doppler of a channel via which the UE communications, one or more parameters of the network node/cell (e.g., the size/type/orientation of the network node antenna arrays, the number of beams in the codebook, the transmit power of the network node, the capabilities of the UE, etc.), the location of the UE (e.g., whether the UE is relatively close or far away from the network node), etc. Examples of characteristics pertaining to beam prediction AI/ML models include, but are not limited to, a distribution (e.g., a maximum, a minimum, a mean, a variance, a standard deviation, a probability density function (PDF), a cumulative distribution function (CDF)) of one or more measured/reported signal metrics (e.g., L1-RSRPs, L1-SINRs, etc.) to be utilized as AI/ML model inputs for model inference, UE mobility characteristics (e.g., moving direction/speed, rotation direction/speed, orientation), UE-estimated angle of arrival and/or angle of departure of network node beams as measurement resources or AI/ML inputs for model inference, transmit beam shapes (e.g., ranges of beam pointing directions (or directions that a beam may point) or beam widths of measurement resources or prediction targets), receive beam shapes (e.g., ranges of beam pointing directions (or directions that a beam may point) or beam widths to measure the signal metrics (e.g., L1-RSRPs/L1-SINRs), etc.

In some aspects, the inference dataset may be configured for model inference utilizing a machine learning model maintained by the UE 804, for example, for predicting at least one of a transmit beam or a receive beam for transmitting or receiving a signal, respectively. In some aspects, the plurality of reference datasets may be configured for training at least one machine model, for example, at the network entity 802.

In some aspects, at 816, the UE 804 may group each of the plurality of reference datasets into a respective group, where each respective group includes a plurality of DBs, and where each of the plurality of DBs includes one or more reference datasets of the plurality of reference datasets. In some aspects, the UE 804 may group the plurality of reference datasets based on at least one of at least one characteristic of the second set of characteristics associated with the inference dataset, the grouping criteria signaled by the network entity 802 (e.g., at 808), or grouping criteria that is predefined or preconfigured.

At 818, the UE 804 may calculate a respective level of similarity between an inference dataset and each of the plurality of reference datasets based on the first set of characteristics and a second set of characteristics associated with the inference dataset. For example, for each reference dataset, the UE 804 may determine a distance between the first set of characteristics associated with the reference dataset and the second set of characteristics associated with the inference dataset. In particular, the UE 804 may featurize the first set of characteristics into one or more first feature vectors based on the first set of characteristics and may featurize the second set of characteristics into one or more second feature vectors based on the second set of characteristics. The UE 804 may determine the distance (e.g., the Euclidean distance) between the first and second feature vectors, where closer the distance between such features, the greater the similarity between the inference dataset and the reference dataset. The feature vectors may take any form, such as a numerical or textual representation, or may take any other suitable form. The UE 804 may featurize the first set of characteristics and the second set of characteristics utilizing time series analysis, keyword 1 featurization, semantic-based featurization, digit-count featurization, n-gram-TFIDF featurization, etc.

At 820, the UE 804 may output at least one indication of the respective level of similarity between the inference dataset and each of the plurality of reference datasets. In some aspects, the UE 804 may output the at least one indication by transmitting the at least one indication to the network entity 802, e.g., as shown at 822. In other aspects, the UE 804 may store the at least one second indication in a memory or a cache, e.g., of the UE 804.

In some aspects, at 822, the UE 804 may transmit a respective indication of the at least one indication for each respective dataset block, where each respective indication includes a respective level of similarity calculated with respect to the one or more reference datasets in each respective dataset block.

In some aspects, the UE may transmit the at least one indication at 822 via one of RRC-based signaling, a MAC-CE, or UCI.

In some aspects, each respective indication of the at least one indication may include one or more bits corresponding to a particular level of similarity, where a number of the one or more bits is based on a number of reference datasets of the plurality of reference datasets within a respective database block. For example, referring to FIG. 7, an indication of the at least one indication may include four bits for each of the four DBs, where the four bits represent the particular level of similarity for the four reference datasets on which each respective DB is based. In another example, an indication of the at least one indication may include two bits for each of the eight DBs, where the two bits represent the particular level of similarity for the eight reference datasets on which each respective DB is based.

At 824, the network entity 802 may provide an indication, to the UE 804, to perform an action. The action indicated by network entity 802 may be based on the respective levels of similarity received by the network entity, for example, at 822. In some aspects, the action may include at least one of suspending, at the UE 804, a utilization of a first machine learning model to perform beam prediction, or switching to a utilization of a second machine learning model to perform the beam prediction.

In some aspects, the network entity 802 may provide a fourth indication of the second machine learning model to the UE 804, for example, at 824. In other aspects, the second machine learning model may be stored at the UE 804.

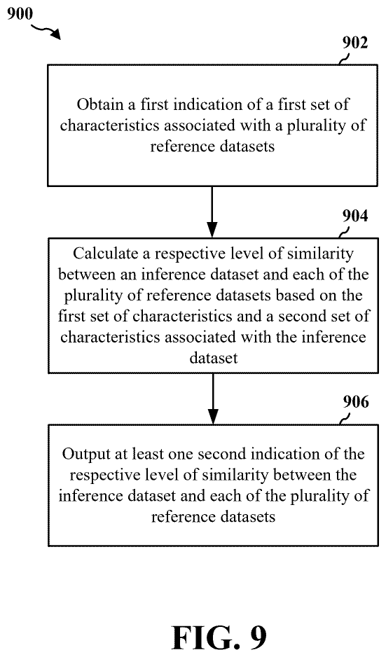

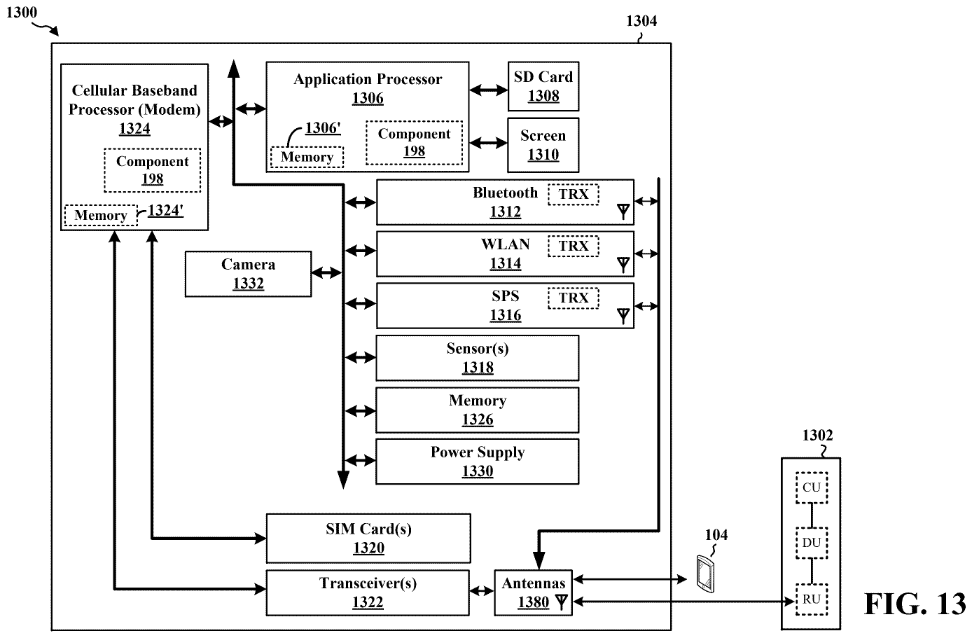

FIG. 9 is a flowchart 900 illustrating methods of wireless communication at a UE in accordance with various aspects of the present disclosure. In some aspects, the UE may be the UE 104, the 350, or the UE 804, or the apparatus 1304 in the hardware implementation of FIG. 13.

At 902, the UE may obtain a first indication of a first set of characteristics associated with a plurality of reference datasets. For example, referring to FIG. 8, the UE 804, at 810, may obtain a first indication of a first set of characteristics associated with a plurality of reference datasets. In an aspect, 902 may be performed by the inference data similarity feedback component 198.

In some aspects, the UE may obtain the first indication by retrieving the first indication from a memory of the UE. For example, referring to FIG. 8, at 810, the UE 804 may retrieve the first indication from a memory of the UE 804.

In some aspects, the UE may obtain the first indication by receiving the first indication from a network entity. For example, referring to FIG. 8, at 812, the UE 804 may receive the first indication from the network entity 802.

At 904, the UE may calculate a respective level of similarity between an inference dataset and each of the plurality of reference datasets based on the first set of characteristics and a second set of characteristics associated with the inference dataset. For example, referring to FIG. 8, the UE 804, at 818, may calculate a respective level of similarity between an inference dataset and each of the plurality of reference datasets based on the first set of characteristics and a second set of characteristics associated with the inference dataset. In an aspect, 904 may be performed by the inference data similarity feedback component 198.

In some aspects, the plurality of reference datasets may be configured for training at least one machine learning model. For example, referring to FIG. 8, the plurality of reference datasets for which the indication of the first set of characteristics is obtained at 810 may be configured for training at least one machine learning model, for example, at the network entity 802.

In some aspects, the inference dataset may be configured for model inference utilizing a machine learning model maintained by the UE. For example, referring to FIG. 8, the inference dataset for which the indication of the second set of characteristics is obtained at 814 may be configured for model inference utilizing a machine learning model maintained by the UE 804.

In some aspects, the first set of characteristics and the second set of characteristics may include at least one of an environment in which the UE is located, at least one profile of a channel via which the UE communicates, at least one parameter of a network entity communicatively coupled to the UE, a location of the UE with respect to the network entity, a distribution of one or more signal metrics utilized for performing beam prediction via a machine learning model, at least one mobility characteristic of the UE, at least one of an estimated angle of arrival or an estimated angle of departure of beams associated with the network entity, a first shape of at least one transmit beam associated with the UE, or a second shape of at least one receive beam associated with the UE. For example, referring to FIG. 8, the first set and second set of characteristics for which the indications were obtained at 810 and 814, respectively, may include at least one of an environment in which the UE 804 is located, at least one profile of a channel via which the UE 804 communicates, at least one parameter of the network entity 802 communicatively coupled to the UE 804, a location of the UE 804 with respect to the network entity 802, a distribution of one or more signal metrics utilized for performing beam prediction via a machine learning model, at least one mobility characteristic of the UE 804, at least one of an estimated angle of arrival or an estimated angle of departure of beams associated with the network entity 802, a first shape of at least one transmit beam associated with the UE 804, or a second shape of at least one receive beam associated with the UE 804.

At 906, the UE may output at least one second indication of the respective level of similarity between the inference dataset and each of the plurality of reference datasets. For example, referring to FIG. 8, the UE 804, at 820, may output at least one second indication of the respective level of similarity between the inference dataset and each of the plurality of reference datasets. In an aspect, 906 may be performed by the inference data similarity feedback component 198.

In some aspects, the UE may output the at least one second indication by transmitting the at least one second indication, or storing the at least one second indication in a memory or a cache. For example, referring to FIG. 8, at 820, the UE 804 may store the at least one second indication in a memory or a cache, for example of the UE 804, or, at 822, may transmit the at least one second indication to the network entity 802.

In some aspects, the UE may group each of the plurality of reference datasets into a respective group, where each respective group includes a plurality of dataset blocks, and where each of the plurality of dataset blocks includes one or more reference datasets of the plurality of reference datasets. For example, referring to FIG. 8, at 816, the UE 804 may group each of the plurality of reference datasets into a respective group, where each respective group includes a plurality of dataset blocks, and where each of the plurality of dataset blocks includes one or more reference datasets of the plurality of reference datasets.

In some aspects, the UE may group each of the plurality of reference datasets is based on at least one of at least one characteristic of the second set of characteristics associated with the inference dataset, first grouping criteria signaled by a network entity, or second grouping criteria that is predefined or preconfigured. For example, referring to FIG. 8, the UE, at 816, may group each of the plurality of reference datasets is based on at least one of at least one characteristic of the second set of characteristics associated with the inference dataset, first grouping criteria signaled by a network entity, or second grouping criteria that is predefined or preconfigured.

In some aspects, the UE may transmit capability signaling that indicates the UE supports an output of the at least one second indication indicating the respective level of similarity between the inference dataset and each of the plurality of reference datasets. For example, referring to FIG. 8, at 806, the UE 804 transmit capability signaling that indicates the UE supports an output of the at least one second indication indicating the respective level of similarity between the inference dataset and each of the plurality of reference datasets.

In some aspects, the UE may transmit capability signaling that indicates a frequency at which the UE outputs the at least one second indication indicating the respective level of similarity between the inference dataset and each of the plurality of reference datasets. For example, referring to FIG. 8, at 806, the UE 804 may transmit capability signaling that indicates a frequency at which the UE outputs the at least one second indication indicating the respective level of similarity between the inference dataset and each of the plurality of reference datasets.

In some aspects, the UE may output the at least one second indication by transmitting a respective second indication of the at least one second indication for each respective dataset block, where each respective second indication includes a respective level of similarity calculated with respect to the one or more reference datasets in each respective dataset block. For example, referring to FIG. 8, the UE 804, at 822, may output the at least one second indication by transmitting a respective second indication of the at least one second indication for each respective dataset block, where each respective second indication includes a respective level of similarity calculated with respect to the one or more reference datasets in each respective dataset block.

In some aspects, each respective second indication of the at least one second indication may include one or more bits corresponding to a particular level of similarity, where a number of the one or more bits is based on a number of reference datasets of the plurality of reference datasets within a respective database block. For example, referring to FIG. 8, each respective at least one second notification outputted at 820 may include one or more bits corresponding to a particular level of similarity, where a number of the one or more bits is based on a number of reference datasets of the plurality of reference datasets within a respective database block For instance, referring to FIG. 7, a second indication of the at least one second indication may include four bits for each of the four DBs, where the four bits represent the particular level of similarity for the four reference datasets on which each respective DB is based. In another example, a second indication of the at least one second indication may include two bits for each of the eight DBs, where the two bits represent the particular level of similarity for the eight reference datasets on which each respective DB is based.

In some aspects, the UE may transmit the at least one second indication by transmitting the at least one second indication via one of RRC-based signaling, a MAC-CE, or UCI. For example, referring to FIG. 8, at 822, the UE 804 may transmit the at least one second indication via one of RRC-based signaling, a MAC-CE, or UCI.

In some aspects, the UE may transmit capability signaling indicating at least one of a maximum number of time domain occasions that are tracked for each respective group, a maximum number of time domain occasions that are tracked for each respective dataset block within each respective group, or a maximum number of dataset blocks supported for each respective group. For example, referring to FIG. 8, the UE 804, at 806, may transmit capability signaling indicating at least one of a maximum number of time domain occasions that are tracked for each respective group, a maximum number of time domain occasions that are tracked for each respective dataset block within each respective group, or a maximum number of dataset blocks supported for each respective group.

In some aspects, the UE may receive a third indication to perform at least one of suspending a utilization of a first machine learning model to perform beam prediction, or switching to a utilization of a second machine learning model to perform the beam prediction. For example, referring to FIG. 8, at 824, the UE 804 may receive, from the network entity 802, a third indication to perform at least one of suspending a utilization of a first machine learning model to perform beam prediction, or switching to a utilization of a second machine learning model to perform the beam prediction.

In some aspects, the UE may receive, from a network entity, a fourth indication of the second machine learning model. For example, referring to FIG. 8, the UE 804 may receive, from the network entity 802, a fourth indication of the second machine learning model, for example, at 824. The indication may indicate to the UE 804 which machine learning model to utilize, a location from which the machine learning model may be retrieved, and/or may include the machine learning model itself.

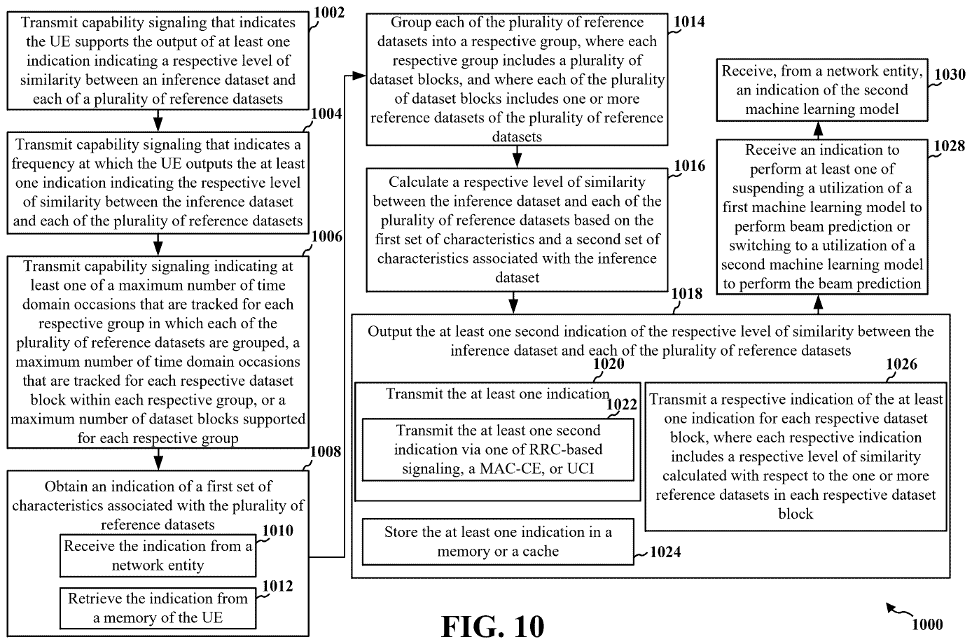

FIG. 10 is a flowchart 1000 illustrating methods of wireless communication at a UE in accordance with various aspects of the present disclosure. In some aspects, the UE may be the UE 104, the 350, or the UE 804, or the apparatus 1304 in the hardware implementation of FIG. 13.

At 1002, the UE may transmit capability signaling that indicates the UE supports an output of the at least one indication indicating a respective level of similarity between an inference dataset and each of a plurality of reference datasets. For example, referring to FIG. 8, at 806, the UE 804 transmit capability signaling that indicates the UE supports an output of the at least one indication indicating the respective level of similarity between the inference dataset and each of the plurality of reference datasets. In an aspect, 1002 may be performed by the inference data similarity feedback component 198.

At 1004, the UE may transmit capability signaling that indicates a frequency at which the UE outputs the at least one indication indicating the respective level of similarity between the inference dataset and each of the plurality of reference datasets. For example, referring to FIG. 8, at 806, the UE 804 may transmit capability signaling that indicates a frequency at which the UE outputs the at least one indication indicating the respective level of similarity between the inference dataset and each of the plurality of reference datasets. In an aspect, 1004 may be performed by the inference data similarity feedback component 198.

At 1006, the UE may transmit capability signaling indicating at least one of a maximum number of time domain occasions that are tracked for each respective group which each of the plurality of reference datasets are grouped, a maximum number of time domain occasions that are tracked for each respective dataset block within each respective group, or a maximum number of dataset blocks supported for each respective group. For example, referring to FIG. 8, the UE 804, at 806, may transmit capability signaling indicating at least one of a maximum number of time domain occasions that are tracked for each respective group, a maximum number of time domain occasions that are tracked for each respective dataset block within each respective group, or a maximum number of dataset blocks supported for each respective group. In an aspect, 1006 may be performed by the inference data similarity feedback component 198.

At 1008, the UE may obtain an indication of a first set of characteristics associated with the plurality of reference datasets. For example, referring to FIG. 8, the UE 804, at 810, may obtain an indication of a first set of characteristics associated with a plurality of reference datasets. In an aspect, 1008 may be performed by the inference data similarity feedback component 198.

In some aspects, as part of 1008, at 1010, the UE may obtain the indication by retrieving the indication from a memory of the UE. For example, referring to FIG. 8, at 810, the UE 804 may retrieve the indication from a memory of the UE 804. In an aspect, 1010 may be performed by the inference data similarity feedback component 198.

In some aspects, as part of 1008, at 1012, the UE may obtain the indication by receiving the indication from a network entity. For example, referring to FIG. 8, at 812, the UE 804 may receive the indication from the network entity 802. In an aspect, 1012 may be performed by the inference data similarity feedback component 198.

At 1014, the UE may group each of the plurality of reference datasets into a respective group, where each respective group includes a plurality of dataset blocks, and where each of the plurality of dataset blocks includes one or more reference datasets of the plurality of reference datasets. For example, referring to FIG. 8, at 816, the UE 804 may group each of the plurality of reference datasets into a respective group, where each respective group includes a plurality of dataset blocks, and where each of the plurality of dataset blocks includes one or more reference datasets of the plurality of reference datasets. In an aspect, 1014 may be performed by the inference data similarity feedback component 198.

In some aspects, the UE may group each of the plurality of reference datasets is based on at least one of at least one characteristic of the second set of characteristics associated with the inference dataset, first grouping criteria signaled by a network entity, or second grouping criteria that is predefined or preconfigured. For example, referring to FIG. 8, the UE, at 816, may group each of the plurality of reference datasets is based on at least one of at least one characteristic of the second set of characteristics associated with the inference dataset, first grouping criteria signaled by a network entity, or second grouping criteria that is predefined or preconfigured.

At 1016, the UE may calculate a respective level of similarity between the inference dataset and each of the plurality of reference datasets based on the first set of characteristics and a second set of characteristics associated with the inference dataset. For example, referring to FIG. 8, the UE 804, at 818, may calculate a respective level of similarity between the inference dataset and each of the plurality of reference datasets based on the first set of characteristics and a second set of characteristics associated with the inference dataset. In an aspect, 1016 may be performed by the inference data similarity feedback component 198.

In some aspects, the plurality of reference datasets may be configured for training at least one machine learning model. For example, referring to FIG. 8, the plurality of reference datasets for which the indication of the first set of characteristics is obtained at 810 may be configured for training at least one machine learning model, for example, at the network entity 802.

In some aspects, the inference dataset may be configured for model inference utilizing a machine learning model maintained by the UE. For example, referring to FIG. 8, the inference dataset for which the indication of the second set of characteristics is obtained at 814 may be configured for model inference utilizing a machine learning model maintained by the UE 804.

In some aspects, the first set of characteristics and the second set of characteristics may include at least one of an environment in which the UE is located, at least one profile of a channel via which the UE communicates, at least one parameter of a network entity communicatively coupled to the UE, a location of the UE with respect to the network entity, a distribution of one or more signal metrics utilized for performing beam prediction via a machine learning model, at least one mobility characteristic of the UE, at least one of an estimated angle of arrival or an estimated angle of departure of beams associated with the network entity, a first shape of at least one transmit beam associated with the UE, or a second shape of at least one receive beam associated with the UE. For example, referring to FIG. 8, the first set and second set of characteristics for which the indications were obtained at 810 and 814, respectively, may include at least one of an environment in which the UE 804 is located, at least one profile of a channel via which the UE 804 communicates, at least one parameter of the network entity 802 communicatively coupled to the UE 804, a location of the UE 804 with respect to the network entity 802, a distribution of one or more signal metrics utilized for performing beam prediction via a machine learning model, at least one mobility characteristic of the UE 804, at least one of an estimated angle of arrival or an estimated angle of departure of beams associated with the network entity 802, a first shape of at least one transmit beam associated with the UE 804, or a second shape of at least one receive beam associated with the UE 804.

At 1018, the UE may output the at least one indication of the respective level of similarity between the inference dataset and each of the plurality of reference datasets. For example, referring to FIG. 8, the UE 804, at 820, may output at least one indication of the respective level of similarity between the inference dataset and each of the plurality of reference datasets. In an aspect, 1018 may be performed by the inference data similarity feedback component 198.

In some aspects, as part of 1018, at 1020, the UE may output the at least one indication by transmitting the at least one indication. For example, referring to FIG. 8, at 822, may transmit the at least one indication to the network entity 802. In an aspect, 1020 may be performed by the inference data similarity feedback component 198. In some aspects, as part of 1020, at 1022, the UE may transmit the at least one indication by transmitting the at least one indication via one of RRC-based signaling, a MAC-CE, or UCI. For example, referring to FIG. 8, at 822, the UE 804 may transmit the at least one indication via one of RRC-based signaling, a MAC-CE, or UCI. In an aspect, 1022 may be performed by the inference data similarity feedback component 198.

In some aspects, as part of 1018, at 1024, the UE may output the at least one second indication by storing the at least one indication in a memory or a cache. For example, referring to FIG. 8, at 820, the UE 804 may store the at least one indication in a memory or a cache, for example of the UE 804. In an aspect, 1024 may be performed by the inference data similarity feedback component 198.

In some aspects, as part of 1018, at 1026, the UE may output the at least one indication by transmitting a respective indication of the at least one indication for each respective dataset block, where each respective indication includes a respective level of similarity calculated with respect to the one or more reference datasets in each respective dataset block. For example, referring to FIG. 8, the UE 804, at 822, may output the at least one indication by transmitting a respective indication of the at least one indication for each respective dataset block, where each respective indication includes a respective level of similarity calculated with respect to the one or more reference datasets in each respective dataset block. In an aspect, 1026 may be performed by the inference data similarity feedback component 198.

In some aspects, each respective indication of the at least one indication may include one or more bits corresponding to a particular level of similarity, where a number of the one or more bits is based on a number of reference datasets of the plurality of reference datasets within a respective database block. For example, referring to FIG. 8, each respective at least one notification outputted at 820 may include one or more bits corresponding to a particular level of similarity, where a number of the one or more bits is based on a number of reference datasets of the plurality of reference datasets within a respective database block For instance, referring to FIG. 7, an indication of the at least one indication may include four bits for each of the four DBs, where the four bits represent the particular level of similarity for the four reference datasets on which each respective DB is based. In another example, an indication of the at least one indication may include two bits for each of the eight DBs, where the two bits represent the particular level of similarity for the eight reference datasets on which each respective DB is based.

At 1028, the UE may receive an indication to perform at least one of suspending a utilization of a first machine learning model to perform beam prediction, or switching to a utilization of a second machine learning model to perform the beam prediction. For example, referring to FIG. 8, at 824, the UE 804 may receive, from the network entity 802, an indication to perform at least one of suspending a utilization of a first machine learning model to perform beam prediction, or switching to a utilization of a second machine learning model to perform the beam prediction. In an aspect, 1028 may be performed by the inference data similarity feedback component 198.

At 1030, the UE may receive, from a network entity, an indication of the second machine learning model. For example, referring to FIG. 8, the UE 804 may receive, from the network entity 802, an indication of the second machine learning model, for example, at 824. The indication may indicate to the UE 804 which machine learning model to utilize, a location from which the machine learning model may be retrieved, and/or may include the machine learning model itself. In an aspect, 1030 may be performed by the inference data similarity feedback component 198.

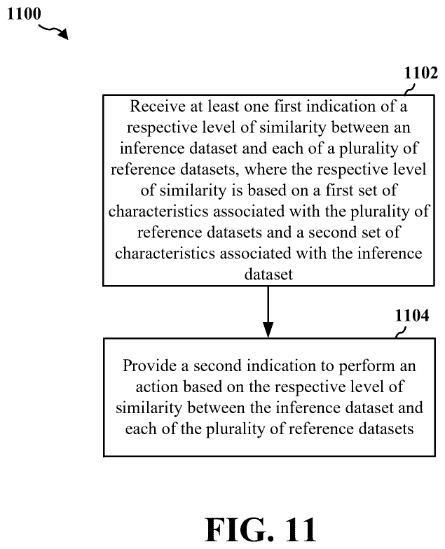

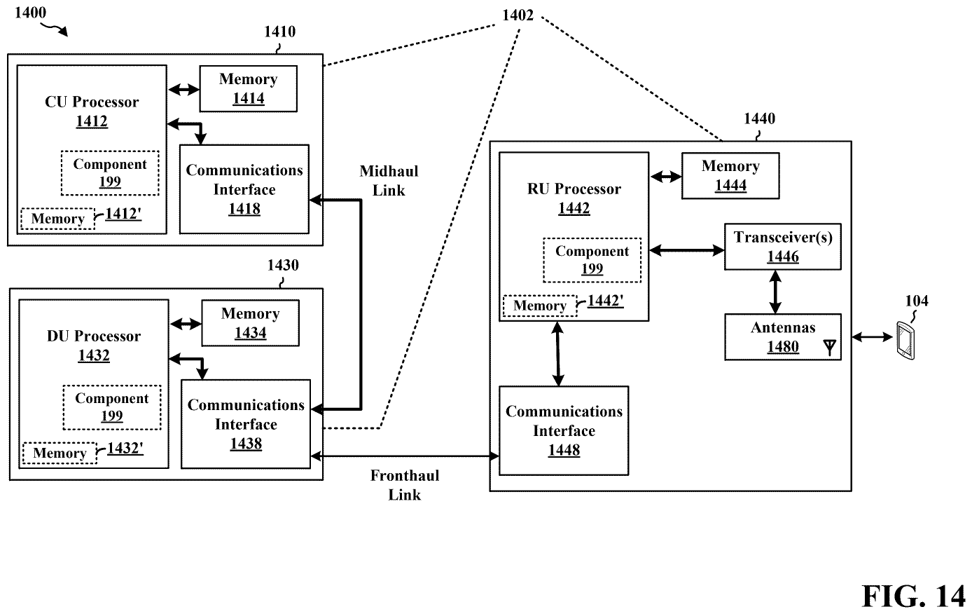

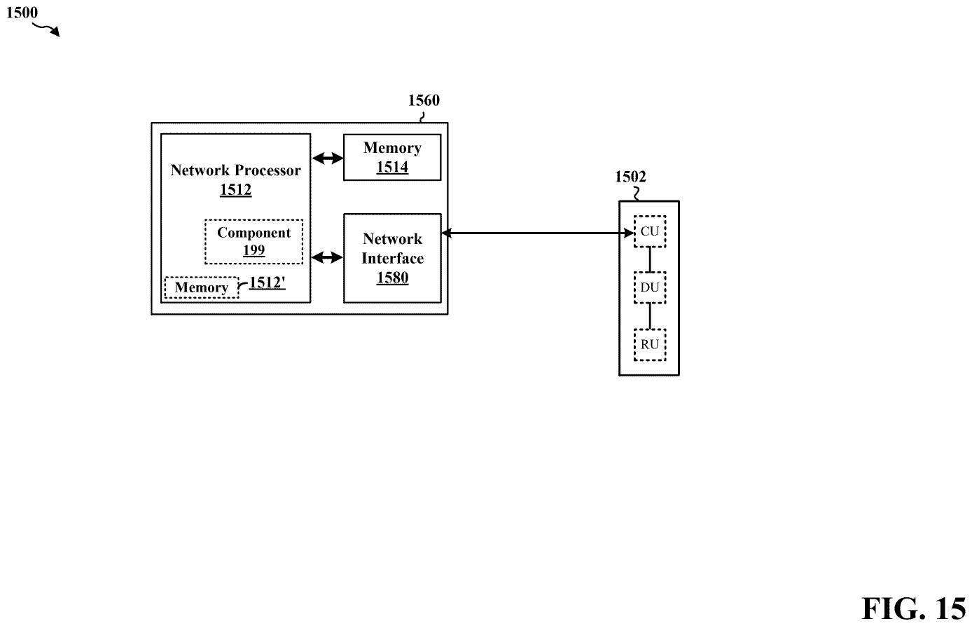

FIG. 11 is a flowchart 1100 illustrating methods of wireless communication at a network entity in accordance with various aspects of the present disclosure. In some aspects, the network entity may be the base station 102, the core network 120, the base station 310, the network entity 802, the network entity 1402 in the hardware implementation of FIG. 14, or the network entity 1560 in the hardware implementation of FIG. 15.

At 1102, the network entity may receive at least one first indication of a respective level of similarity between an inference dataset and each of a plurality of reference datasets, where the respective level of similarity is based on a first set of characteristics associated with the plurality of reference datasets and a second set of characteristics associated with the inference dataset. For example, referring to FIG. 8, at 822, the network entity 802 may receive, from the UE 804, at least one first indication of a respective level of similarity between an inference dataset and each of a plurality of reference datasets, where the respective level of similarity is based on a first set of characteristics associated with the plurality of reference datasets and a second set of characteristics associated with the inference dataset. In an aspect, 1102 may be performed by the inference data similarity analysis component 199. In some aspects, the network entity may receive the at least one first indication by receiving the at least one first indication via one of RRC-based signals, a MAC-CE, or UCI. For example, referring to FIG. 8, at 822, the network entity 802 may receive the at least one first indication by receiving the at least one first indication via one of RRC-based signals, a MAC-CE, or UCI.

In some aspects, the first set of characteristics and the second set of characteristics may include at least one of an environment in which a UE communicatively coupled to the network entity is located, at least one profile of a channel via which the UE communicates, at least one parameter of the network entity, a location of the UE with respect to the network entity, a distribution of one or more signal metrics utilized for performing beam prediction via a machine learning model, at least one mobility characteristic of the UE, at least one of an estimated angle of arrival or an estimated angle of departure of beams associated with the network entity, a first shape of at least one transmit beam associated with the UE, or a second shape of at least one receive beam associated with the UE. For example, referring to FIG. 8, the first set of characteristics associated with the plurality of reference datasets and the second set of characteristics associated with the inference dataset on which the at least one first indication received at 822 is based may include at least one of an environment in which the UE 804 is located, at least one profile of a channel via which the UE 804 communicates, at least one parameter of the network entity 802 communicatively coupled to the UE 804, a location of the UE 804 with respect to the network entity 802, a distribution of one or more signal metrics utilized for performing beam prediction via a machine learning model, at least one mobility characteristic of the UE 804, at least one of an estimated angle of arrival or an estimated angle of departure of beams associated with the network entity 802, a first shape of at least one transmit beam associated with the UE 804, or a second shape of at least one receive beam associated with the UE 804.

At 1104, the network entity may provide a second indication to perform an action based on the respective level of similarity between the inference dataset and each of the plurality of reference datasets. For example, referring to FIG. 8, at 824, the network entity 802 may provide, to the UE 804, a second indication to perform an action based on the respective level of similarity between the inference dataset and each of the plurality of reference datasets. In an aspect, 1104 may be performed by the inference data similarity analysis component 199.

In some aspects, the action includes at least one of suspending a utilization of a first machine learning model to perform beam prediction or switching to a utilization of a second machine learning model to perform the beam prediction. For example, referring to FIG. 8, the action indicated at 824 may be for the UE 804 to perform at least one of suspending a utilization of a first machine learning model to perform beam prediction or switching to a utilization of a second machine learning model to perform the beam prediction.

In some aspects, the network entity may provide, for a UE, a third indication of the second machine learning model. For example, referring to FIG. 8, at 824, the network entity 802 may provide, for the UE, a third indication of the second machine learning model. The third indication may indicate to the UE 804 which machine learning model to utilize, a location from which the machine learning model may be retrieved, and/or may include the machine learning model itself.

In some aspects, the network entity may provide a third indication of the first set of characteristics associated with the plurality of reference datasets. For example, referring to FIG. 8, at 812, the network entity 802 may provide, to the UE 804, a third indication of the first set of characteristics associated with the plurality of reference datasets.

In some aspects, the network entity may provide, for a UE, a third indication of criteria utilized for grouping each of the plurality of reference datasets into a respective group, where each respective group includes a plurality of dataset blocks, and where each of the plurality of dataset blocks includes one or more reference datasets of the plurality of reference datasets. For example, referring to FIG. 8, at 808, the network entity 802 may provide, for the UE 804, a third indication of criteria utilized for grouping each of the plurality of reference datasets into a respective group, where each respective group includes a plurality of dataset blocks, and where each of the plurality of dataset blocks includes one or more reference datasets of the plurality of reference datasets.

In some aspects, the network entity may receive, from the UE, capability signaling indicating at least one of a maximum number of time domain occasions that are tracked at the UE for each respective group, a maximum number of time domain occasions that are tracked at the UE for each respective dataset block within each respective group, or a maximum number of dataset blocks supported for each respective group. For example, referring to FIG. 8, at 806, the network entity 802 may receive, from the UE 804 capability signaling indicating at least one of a maximum number of time domain occasions that are tracked at the UE 804 for each respective group, a maximum number of time domain occasions that are tracked at the UE 804 for each respective dataset block within each respective group, or a maximum number of dataset blocks supported for each respective group.

In some aspects, each respective first indication of the at least one first indication includes one or more bits corresponding to a particular level of similarity, and where a number of the one or more bits is based on a number of reference datasets of the plurality of reference datasets within a respective database block. For example, referring to FIG. 8, the indication(s) received at 822 may include one or more bits corresponding to a particular level of similarity, and where a number of the one or more bits is based on a number of reference datasets of the plurality of reference datasets within a respective database block. For instance, referring to FIG. 7, a respective first indication of the at least one first indication may include four bits for each of the four DBs, where the four bits represent the particular level of similarity for the four reference datasets on which each respective DB is based. In another example, a respective first indication of the at least one first indication may include two bits for each of the eight DBs, where the two bits represent the particular level of similarity for the eight reference datasets on which each respective DB is based.

In some aspects, the network entity may receive, from a UE, capability signaling that indicates that the UE supports a transmission of the at least one first indication indicating the respective level of similarity between the inference dataset and each of the plurality of reference datasets. For example, referring to FIG. 8, at 806, the network entity 802 may receive, from the UE 804, capability signaling that indicates that the UE 804 supports a transmission of the at least one first indication indicating the respective level of similarity between the inference dataset and each of the plurality of reference datasets.

In some aspects, the network entity may receive, from a UE, capability signaling indicating a frequency at which the UE transmits the at least one first indication indicating the respective level of similarity between the inference dataset and each of the plurality of reference datasets. For example, referring to FIG. 8, at 806, the network entity 802 may receive, from the UE 804, capability signaling indicating a frequency at which the UE 804 transmits the at least one first indication indicating the respective level of similarity between the inference dataset and each of the plurality of reference datasets.

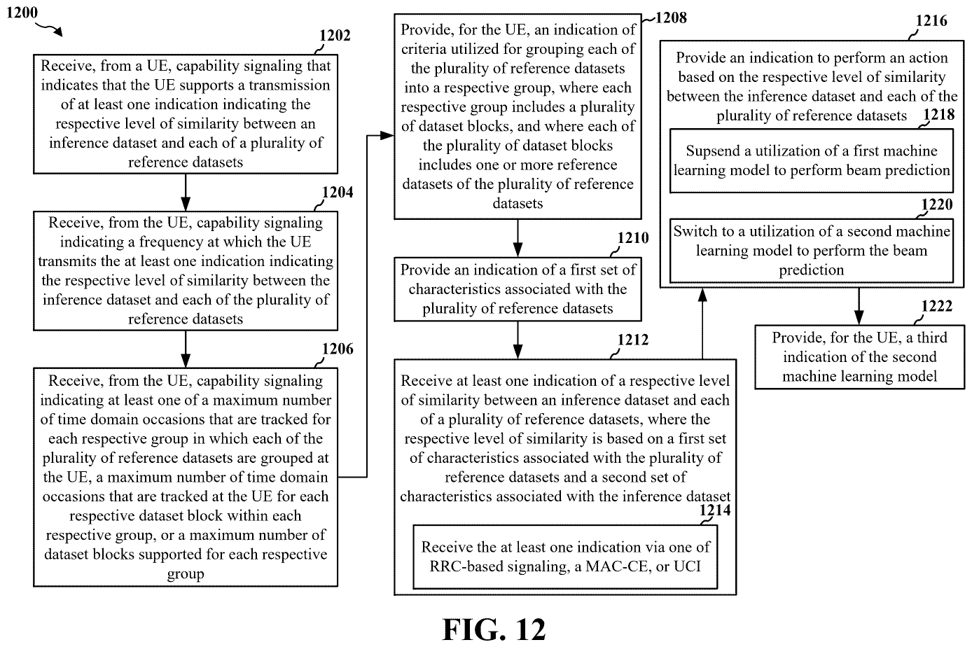

FIG. 12 is a flowchart 1200 illustrating methods of wireless communication at a network entity in accordance with various aspects of the present disclosure. In some aspects, the network entity may be the base station 102, the core network 120, the base station 310, the network entity 802, the network entity 1402 in the hardware implementation of FIG. 14, or the network entity 1560 in the hardware implementation of FIG. 15.

At 1202, the network entity may receive, from a UE, capability signaling that indicates that the UE supports a transmission of the at least one indication indicating the respective level of similarity between an inference dataset and each of a plurality of reference datasets. For example, referring to FIG. 8, at 806, the network entity 802 may receive, from the UE 804, capability signaling that indicates that the UE 804 supports a transmission of the at least one indication indicating the respective level of similarity between an inference dataset and each of the plurality of reference datasets.

At 1204, the network entity may receive, from a UE, capability signaling indicating a frequency at which the UE transmits the at least one indication indicating the respective level of similarity between the inference dataset and each of the plurality of reference datasets. For example, referring to FIG. 8, at 806, the network entity 802 may receive, from the UE 804, capability signaling indicating a frequency at which the UE 804 transmits the at least one indication indicating the respective level of similarity between the inference dataset and each of the plurality of reference datasets.

At 1206, the network entity may receive, from the UE, capability signaling indicating at least one of a maximum number of time domain occasions that are tracked at the UE for each respective group in which each of the plurality of reference datasets are grouped at the UE, a maximum number of time domain occasions that are tracked at the UE for each respective dataset block within each respective group, or a maximum number of dataset blocks supported for each respective group. For example, referring to FIG. 8, at 806, the network entity 802 may receive, from the UE 804 capability signaling indicating at least one of a maximum number of time domain occasions that are tracked at the UE 804 for each respective group in which each of the plurality of reference datasets are grouped at the UE 804, a maximum number of time domain occasions that are tracked at the UE for each respective dataset block within each respective group, or a maximum number of dataset blocks supported for each respective group.

At 1208, the network entity may provide, for a UE, an indication of criteria utilized for grouping each of the plurality of reference datasets into a respective group, where each respective group includes a plurality of dataset blocks, and where each of the plurality of dataset blocks includes one or more reference datasets of the plurality of reference datasets. For example, referring to FIG. 8, at 808, the network entity 802 may provide, for the UE 804, an indication of criteria utilized for grouping each of the plurality of reference datasets into a respective group, where each respective group includes a plurality of dataset blocks, and where each of the plurality of dataset blocks includes one or more reference datasets of the plurality of reference datasets. The indication of criteria may be based on the capability signaling provided by the UE 804 at 806.

At 1210, the network entity may provide an indication of the first set of characteristics associated with the plurality of reference datasets. For example, referring to FIG. 8, at 812, the network entity 802 may provide, to the UE 804, an indication of the first set of characteristics associated with the plurality of reference datasets.

At 1212, the network entity may receive at least one indication of a respective level of similarity between the inference dataset and each of the plurality of reference datasets, where the respective level of similarity is based on a first set of characteristics associated with the plurality of reference datasets and a second set of characteristics associated with the inference dataset. For example, referring to FIG. 8, at 822, the network entity 802 may receive, from the UE 804, at least one indication of a respective level of similarity between an inference dataset and each of a plurality of reference datasets, where the respective level of similarity is based on a first set of characteristics associated with the plurality of reference datasets and a second set of characteristics associated with the inference dataset. In an aspect, 1212 may be performed by the inference data similarity analysis component 199.

In some aspects, each respective first indication of the at least one first indication includes one or more bits corresponding to a particular level of similarity, and where a number of the one or more bits is based on a number of reference datasets of the plurality of reference datasets within a respective database block. For example, referring to FIG. 8, the indication(s) received at 822 may include one or more bits corresponding to a particular level of similarity, and where a number of the one or more bits is based on a number of reference datasets of the plurality of reference datasets within a respective database block. For instance, referring to FIG. 7, a respective first indication of the at least one first indication may include four bits for each of the four DBs, where the four bits represent the particular level of similarity for the four reference datasets on which each respective DB is based. In another example, a respective first indication of the at least one first indication may include two bits for each of the eight DBs, where the two bits represent the particular level of similarity for the eight reference datasets on which each respective DB is based.

In some aspects, as part of 1212, at 1214, the network entity may receive the at least one indication by receiving the at least one indication via one of RRC-based signals, a MAC-CE, or UCI. For example, referring to FIG. 8, at 822, the network entity 802 may receive the at least one indication by receiving the at least one indication via one of RRC-based signals, a MAC-CE, or UCI.

In some aspects, the first set of characteristics and the second set of characteristics may include at least one of an environment in which a UE communicatively coupled to the network entity is located, at least one profile of a channel via which the UE communicates, at least one parameter of the network entity, a location of the UE with respect to the network entity, a distribution of one or more signal metrics utilized for performing beam prediction via a machine learning model, at least one mobility characteristic of the UE, at least one of an estimated angle of arrival or an estimated angle of departure of beams associated with the network entity, a first shape of at least one transmit beam associated with the UE, or a second shape of at least one receive beam associated with the UE. For example, referring to FIG. 8, the first set of characteristics associated with the plurality of reference datasets and the second set of characteristics associated with the inference dataset on which the at least one first indication received at 822 is based may include at least one of an environment in which the UE 804 is located, at least one profile of a channel via which the UE 804 communicates, at least one parameter of the network entity 802 communicatively coupled to the UE 804, a location of the UE 804 with respect to the network entity 802, a distribution of one or more signal metrics utilized for performing beam prediction via a machine learning model, at least one mobility characteristic of the UE 804, at least one of an estimated angle of arrival or an estimated angle of departure of beams associated with the network entity 802, a first shape of at least one transmit beam associated with the UE 804, or a second shape of at least one receive beam associated with the UE 804.

At 1216, the network entity may provide an indication to perform an action based on the respective level of similarity between the inference dataset and each of the plurality of reference datasets. For example, referring to FIG. 8, at 824, the network entity 802 may provide, to the UE 804, an indication to perform an action based on the respective level of similarity between the inference dataset and each of the plurality of reference datasets. In an aspect, 1216 may be performed by the inference data similarity analysis component 199.

In some aspects, as part of 1216, at 1218, the action may include suspending a utilization of a first machine learning model to perform beam prediction. For example, referring to FIG. 8, the action indicated at 824 may be for the UE 804 to perform suspending a utilization of a first machine learning model to perform beam prediction.

In some aspects, as part of 1216, at 1220, the action may include switching to a utilization of a second machine learning model to perform the beam prediction. For example, referring to FIG. 8, the action indicated at 824 may be for the UE 804 to perform switching to a utilization of a second machine learning model to perform the beam prediction.

At 1222, the network entity may provide, for a UE, an indication of the second machine learning model. For example, referring to FIG. 8, at 824, the network entity 802 may provide, for the UE, an indication of the second machine learning model. The third indication may indicate to the UE 804 which machine learning model to utilize, a location from which the machine learning model may be retrieved, and/or may include the machine learning model itself.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see UE 350 of FIG. 3) and include the additional modules of the apparatus 1304.

As discussed supra, the component 198 may be configured to obtain a first indication of a first set of characteristics associated with a plurality of reference datasets, to calculate a respective level of similarity between an inference dataset and each of the plurality of reference datasets based on the first set of characteristics and a second set of characteristics associated with the inference dataset, and to output at least one second indication of the respective level of similarity between the inference dataset and each of the plurality of reference datasets. The component 198 may be configured to perform any of the aspects described in connection with the flowcharts in FIGS. 9 and 10, the machine learning algorithm functions in FIG. 4 or 5, and/or the aspects performed by the UE 804 in the communication flow in FIG. 8. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, may include means for obtaining a first indication of a first set of characteristics associated with a plurality of reference datasets, means for calculating a respective level of similarity between an inference dataset and each of the plurality of reference datasets based on the first set of characteristics and a second set of characteristics associated with the inference dataset, and means for outputting at least one second indication of the respective level of similarity between the inference dataset and each of the plurality of reference datasets. The apparatus may further include means for performing any of the aspects described in connection with the flowcharts in FIGS. 9 and 10, the machine learning algorithm functions in FIG. 4 or 5, and/or the aspects performed by the UE 804 in the communication flow in FIG. 8. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive at least one first indication of a respective level of similarity between an inference dataset and each of a plurality of reference datasets, where the respective level of similarity is based on a first set of characteristics associated with the plurality of reference datasets and a second set of characteristics associated with the inference dataset, and to provide a second indication to perform an action based on the respective level of similarity between the inference dataset and each of the plurality of reference datasets. The component 199 may be configured to perform any of the aspects described in connection with the flowcharts in FIGS. 11 and 12 and/or the aspects performed by the network entity 802 in the communication flow in FIG. 8. The component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 may include means for receiving at least one first indication of a respective level of similarity between an inference dataset and each of a plurality of reference datasets, where the respective level of similarity is based on a first set of characteristics associated with the plurality of reference datasets and a second set of characteristics associated with the inference dataset, and means for providing a second indication to perform an action based on the respective level of similarity between the inference dataset and each of the plurality of reference datasets. The apparatus may further include means for performing any of the aspects described in connection with the flowcharts in FIGS. 11 and 12, and/or the aspects performed by the network entity 802 in the communication flow in FIG. 8. The means may be the component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive at least one first indication of a respective level of similarity between an inference dataset and each of a plurality of reference datasets, where the respective level of similarity is based on a first set of characteristics associated with the plurality of reference datasets and a second set of characteristics associated with the inference dataset, and to provide a second indication to perform an action based on the respective level of similarity between the inference dataset and each of the plurality of reference datasets. The component 199 may be configured to perform any of the aspects described in connection with the flowcharts in FIGS. 11 and 12 and/or the aspects performed by the network entity 802 in the communication flow in FIG. 8. The component 199 may be within the processor 1512. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 may include means for receiving at least one first indication of a respective level of similarity between an inference dataset and each of a plurality of reference datasets, where the respective level of similarity is based on a first set of characteristics associated with the plurality of reference datasets and a second set of characteristics associated with the inference dataset, and means for providing a second indication to perform an action based on the respective level of similarity between the inference dataset and each of the plurality of reference datasets. The apparatus may further include means for performing any of the aspects described in connection with the flowcharts in FIGS. 11 and 12, and/or the aspects performed by the network entity 802 in the communication flow in FIG. 8. The means may be the component 199 of the network entity 1560 configured to perform the functions recited by the means.

Various aspects of the present disclosure, in connection with the accompanying drawings, relate generally to communication systems. Some aspects more specifically relate to machine learning for predictive beam management. In some examples, a UE may receive obtain an indication of first set of characteristics associated with a plurality of reference datasets. The plurality of reference datasets may be utilized to train a machine learning mode (e.g., at a network entity). The UE may calculate a respective level of similarity between an inference dataset and each of the plurality of reference datasets based on the first set of characteristics and a second set of characteristics associated with the inference dataset. The inference dataset may be utilized at the UE to perform model inference via machine learning model (e.g., to perform beam prediction). For each respective reference dataset of the plurality of reference datasets, the UE may output a respective indication of the respective level of similarity between the inference dataset and the respective reference dataset. The respective indications may be provided to a network entity. The network entity may determine an action to be performed at the UE based on the respective indications. Such actions include, but are not limited to, suspending the machine learning model utilized at the UE or switching to a different machine learning model.

Particular aspects of the subject matter described in this disclosure can be implemented to realize one or more of the following potential advantages. In some examples, by outputting respective indications of respective levels of similarity between the inference dataset and the plurality of reference datasets, the network entity may determine the effectiveness of the machine learning model utilized at the UE with respect to the environment in which the UE is located. In the event that the network node determines that the machine learning model utilized at the UE is relatively ineffective based on the respective levels of similarity, the network entity may cause the UE to utilize a different machine learning model that is tailored to the environment in which the UE is located. Such a machine learning model may more accurately predict an optimal transmit beam for transmitting signals and/or an optimal receive beam for receiving signals. Accordingly, the aspects of the subject matter described in this disclosure may improve the signal-to-noise ratio of received signals, eliminate undesirable interference sources, and focus transmitted signals to desired locations.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: obtaining a first indication of a first set of characteristics associated with a plurality of reference datasets; calculating a respective level of similarity between an inference dataset and each of the plurality of reference datasets based on the first set of characteristics and a second set of characteristics associated with the inference dataset; and outputting at least one second indication of the respective level of similarity between the inference dataset and each of the plurality of reference datasets.

Aspect 2 is the method of aspect 1, further comprising: grouping each of the plurality of reference datasets into a respective group, wherein each respective group comprises a plurality of dataset blocks, and wherein each of the plurality of dataset blocks comprises one or more reference datasets of the plurality of reference datasets.

Aspect 3 is the method of aspect 2, wherein outputting the at least one second indication comprises: transmitting a respective second indication of the at least one second indication for each respective dataset block, wherein each respective second indication comprises a respective level of similarity calculated with respect to the one or more reference datasets in each respective dataset block.

Aspect 4 is the method of any of aspects 2 and 3, further comprising: transmitting capability signaling indicating at least one of: a maximum number of time domain occasions that are tracked for each respective group; a maximum number of time domain occasions that are tracked for each respective dataset block within each respective group; or a maximum number of dataset blocks supported for each respective group.

Aspect 5 is the method of any of aspects 2 to 4, wherein grouping each of the plurality of reference datasets is based on at least one of: at least one characteristic of the second set of characteristics associated with the inference dataset; first grouping criteria signaled by a network entity; or second grouping criteria that is predefined or preconfigured.

Aspect 6 is the method of any of aspects 2 to 5, wherein each respective second indication of the at least one second indication comprises one or more bits corresponding to a particular level of similarity, and wherein a number of the one or more bits is based on a number of reference datasets of the plurality of reference datasets within a respective database block.

Aspect 7 is the method of any of aspects 2 to 6, further comprising receiving a third indication to perform at least one of suspending a utilization of a first machine learning model to perform beam prediction; or switching to a utilization of a second machine learning model to perform the beam prediction.

Aspect 8 is the method of aspect 7, further comprising: receiving, from a network entity, a fourth indication of the second machine learning model.

Aspect 9 is the method of any of aspects 1 to 8, wherein the inference dataset is configured for model inference utilizing a machine learning model maintained by the UE.

Aspect 10 is the method of any of aspects 1 to 9, wherein the plurality of reference datasets is configured for training at least one machine learning model.

Aspect 11 is the method of any of aspects 1 to 10, wherein obtaining the first indication of the first set of characteristics comprises: receiving the first indication from a network entity.

Aspect 12 is the method of any of aspects 1 to 10, wherein obtaining the first indication of the first set of characteristics comprises: retrieving the first indication from a memory of the UE.

Aspect 13 is the method of any of aspects 1 to 12, further comprising: transmitting capability signaling that indicates the UE supports an output of the at least one second indication indicating the respective level of similarity between the inference dataset and each of the plurality of reference datasets.

Aspect 14 is the method of any of aspects 1 to 13, further comprising: transmitting capability signaling that indicates a frequency at which the UE outputs the at least one second indication indicating the respective level of similarity between the inference dataset and each of the plurality of reference datasets.

Aspect 15 is the method of any of aspects 1 to 14, wherein the first set of characteristics and the second set of characteristics comprise at least one of: an environment in which the UE is located; at least one profile of a channel via which the UE communicates; at least one parameter of a network entity communicatively coupled to the UE; a location of the UE with respect to the network entity; a distribution of one or more signal metrics utilized for performing beam prediction via a machine learning model; at least one mobility characteristic of the UE; at least one of an estimated angle of arrival or an estimated angle of departure of beams associated with the network entity; a first shape of at least one transmit beam associated with the UE; or a second shape of at least one receive beam associated with the UE.

Aspect 16 is the method of any of aspects 1 to 15, wherein outputting the at least one second indication comprises: transmitting the at least one second indication; or storing the at least one second indication in a memory or a cache.

Aspect 17 is the method of aspect 16, wherein transmitting the at least one second indication comprises: transmitting the at least one second indication via one of: radio resource control (RRC)-based signaling; a medium access control (MAC)-control element (MAC-CE); or uplink control information (UCI).

Aspect 18 is a method of wireless communication at a network entity, comprising: receiving at least one first indication of a respective level of similarity between an inference dataset and each of a plurality of reference datasets, wherein the respective level of similarity is based on a first set of characteristics associated with the plurality of reference datasets and a second set of characteristics associated with the inference dataset; and providing a second indication to perform an action based on the respective level of similarity between the inference dataset and each of the plurality of reference datasets.

Aspect 19 is the method of aspect 18, further comprising: providing a third indication of the first set of characteristics associated with the plurality of reference datasets.

Aspect 20 is the method of any of aspects 18 and 19, further comprising: providing, for a user equipment (UE), a third indication of criteria utilized for grouping each of the plurality of reference datasets into a respective group, wherein each respective group comprises a plurality of dataset blocks, and wherein each of the plurality of dataset blocks comprises one or more reference datasets of the plurality of reference datasets.

Aspect 21 is the method of aspect 20, further comprising: receiving, from the UE, capability signaling indicating at least one of: a maximum number of time domain occasions that are tracked at the UE for each respective group; a maximum number of time domain occasions that are tracked at the UE for each respective dataset block within each respective group; or a maximum number of dataset blocks supported for each respective group.

Aspect 22 is the method of any of aspects 20 and 21, wherein each respective first indication of the at least one first indication comprises one or more bits corresponding to a particular level of similarity, and wherein a number of the one or more bits is based on a number of reference datasets of the plurality of reference datasets within a respective database block.

Aspect 23 is the method of any of aspects 18 to 22, wherein the action comprises at least one of: suspending a utilization of a first machine learning model to perform beam prediction; or switching to a utilization of a second machine learning model to perform the beam prediction.

Aspect 24 is the method of aspect 23, further comprising: providing, for a user equipment (UE), an indication of the second machine learning model.

Aspect 25 is the method of any of aspects 18 to 24, further comprising: receiving, from a user equipment (UE), capability signaling that indicates that the UE supports a transmission of the at least one first indication indicating the respective level of similarity between the inference dataset and each of the plurality of reference datasets.

Aspect 26 is the method of any of aspects 18 to 25, further comprising: receiving, from a user equipment (UE), capability signaling indicating a frequency at which the UE transmits the at least one first indication indicating the respective level of similarity between the inference dataset and each of the plurality of reference datasets.

Aspect 27 is the method of any of aspects 18 to 26, wherein the first set of characteristics and the second set of characteristics comprise at least one of: an environment in which a UE communicatively coupled to the network entity is located; at least one profile of a channel via which the UE communicates; at least one parameter of the network entity; a location of the UE with respect to the network entity; a distribution of one or more signal metrics utilized for performing beam prediction at the UE via a machine learning model; at least one mobility characteristic of the UE; at least one of an estimated angle of arrival or an estimated angle of departure of beams associated with the network entity; a first shape of at least one transmit beam associated with the UE; or a second shape of at least one receive beam associated with the UE.

Aspect 28 is the method of any of aspects 18 to 27, wherein receiving the at least one first indication comprises: receiving the at least one first indication via one of: radio resource control (RRC)-based signaling; a medium access control (MAC)-control element (MAC-CE); or uplink control information (UCI).

Aspect 29 is an apparatus for wireless communication at a UE. The apparatus includes memory; and at least one processor coupled to the memory and, based at least in part on information stored in the memory, the at least one processor is configured to implement any of aspects 1 to 17.

Aspect 30 is the apparatus of aspect 29, further including at least one of a transceiver or an antenna coupled to the at least one processor.

Aspect 31 is an apparatus for wireless communication at a network entity. The apparatus includes memory; and at least one processor coupled to the memory and, based at least in part on information stored in the memory, the at least one processor is configured to implement any of aspects 18 to 28.

Aspect 32 is the apparatus of aspect 31, further including at least one of a transceiver or an antenna coupled to the at least one processor.

Aspect 33 is an apparatus for wireless communication including means for implementing any of aspects 1 to 17.

Aspect 34 is an apparatus for wireless communication including means for implementing any of aspects 18 to 28.

Aspect 35 is a computer-readable medium (e.g., a non-transitory computer-readable medium) storing computer executable code, where the code when executed by a processor causes the processor to implement any of aspects 1 to 17.

Aspect 36 is a computer-readable medium (e.g., a non-transitory computer-readable medium) storing computer executable code, where the code when executed by a processor causes the processor to implement any of aspects 18 to 28.

1. An apparatus for wireless communication at a user equipment (UE), comprising:
a memory; and
at least one processor coupled to the memory, the memory storing instructions executable by the at least one processor to cause the apparatus to:
obtain a first indication of a first set of characteristics associated with a plurality of reference datasets;
calculate a respective level of similarity between an inference dataset and each of the plurality of reference datasets based on the first set of characteristics and a second set of characteristics associated with the inference dataset; and
output at least one second indication of the respective level of similarity between the inference dataset and each of the plurality of reference datasets.

2. The apparatus of claim 1, wherein the memory further stores instructions executable by the at least one processor to cause the apparatus to:
group each of the plurality of reference datasets into a respective group, wherein each respective group comprises a plurality of dataset blocks, and wherein each of the plurality of dataset blocks comprises one or more reference datasets of the plurality of reference datasets.

3. The apparatus of claim 2, wherein the memory further stores instructions executable by the at least one processor to cause the apparatus to:
transmit a respective second indication of the at least one second indication for each respective dataset block, wherein each respective second indication comprises a respective level of similarity calculated with respect to the one or more reference datasets in each respective dataset block.

4. The apparatus of claim 2, wherein the memory further stores instructions executable by the at least one processor to cause the apparatus to:
transmit capability signaling indicating at least one of:
a maximum number of time domain occasions that are tracked for each respective group;
a maximum number of time domain occasions that are tracked for each respective dataset block within each respective group; or
a maximum number of dataset blocks supported for each respective group.

5. The apparatus of claim 2, wherein grouping each of the plurality of reference datasets is based on at least one of:
at least one characteristic of the second set of characteristics associated with the inference dataset;
first grouping criteria signaled by a network entity; or
second grouping criteria that is predefined or preconfigured.

6. The apparatus of claim 2, wherein each respective second indication of the at least one second indication comprises one or more bits corresponding to a particular level of similarity, and wherein a number of the one or more bits is based on a number of reference datasets of the plurality of reference datasets within a respective database block.

7. The apparatus of claim 1, wherein the memory further stores instructions executable by the at least one processor to cause the apparatus to receive a third indication to perform at least one of:
a suspension of a utilization of a first machine learning model to perform beam prediction; or
a switch to a utilization of a second machine learning model to perform the beam prediction.

8. The apparatus of claim 7, wherein the memory further stores instructions executable by the at least one processor to cause the apparatus to:
receive, from a network entity, a fourth indication of the second machine learning model.

9. The apparatus of claim 1, wherein the inference dataset is configured for model inference utilizing a machine learning model maintained by the UE.

10. The apparatus of claim 1, wherein the plurality of reference datasets is configured for training at least one machine learning model.

11. The apparatus of claim 1, wherein the memory further stores instructions executable by the at least one processor to cause the apparatus to:
receive the first indication from a network entity.

12. The apparatus of claim 1, wherein the memory further stores instructions executable by the at least one processor to cause the apparatus to:
retrieve the first indication from a memory of the UE.

13. The apparatus of claim 1, wherein the memory further stores instructions executable by the at least one processor to cause the apparatus to:
transmit capability signaling that indicates the UE supports an output of the at least one second indication indicating the respective level of similarity between the inference dataset and each of the plurality of reference datasets.

14. The apparatus of claim 1, wherein the memory further stores instructions executable by the at least one processor to cause the apparatus to:
transmit capability signaling that indicates a frequency at which the UE outputs the at least one second indication indicating the respective level of similarity between the inference dataset and each of the plurality of reference datasets.

15. The apparatus of claim 1, wherein the first set of characteristics and the second set of characteristics comprise at least one of:
an environment in which the UE is located;
at least one profile of a channel via which the UE communicates;
at least one parameter of a network entity communicatively coupled to the UE;
a location of the UE with respect to the network entity;
a distribution of one or more signal metrics utilized for performing beam prediction via a machine learning model;
at least one mobility characteristic of the UE;
at least one of an estimated angle of arrival or an estimated angle of departure of beams associated with the network entity;
a first shape of at least one transmit beam associated with the UE; or
a second shape of at least one receive beam associated with the UE.

16. The apparatus of claim 1, wherein the memory further stores instructions executable by the at least one processor to cause the apparatus to:
transmit the at least one second indication; or
store the at least one second indication in a memory or a cache.

17. The apparatus of claim 16, wherein the memory further stores instructions executable by the at least one processor to cause the apparatus to:
transmit the at least one second indication via one of:
radio resource control (RRC)-based signaling;
a medium access control (MAC)-control element (MAC-CE); or
uplink control information (UCI).

18. An apparatus for wireless communication at a network entity, comprising:
a memory; and
at least one processor coupled to the memory, the memory storing instructions executable by the at least one processor to cause the apparatus to:
receive at least one first indication of a respective level of similarity between an inference dataset and each of a plurality of reference datasets, wherein the respective level of similarity is based on a first set of characteristics associated with the plurality of reference datasets and a second set of characteristics associated with the inference dataset; and
provide a second indication to perform an action based on the respective level of similarity between the inference dataset and each of the plurality of reference datasets.

19. The apparatus of claim 18, wherein the memory further stores instructions executable by the at least one processor to cause the apparatus to:
provide a third indication of the first set of characteristics associated with the plurality of reference datasets.

20.-28. (canceled)

29. A method for wireless communication at a user equipment (UE), comprising:
obtaining a first indication of a first set of characteristics associated with a plurality of reference datasets;
calculating a respective level of similarity between an inference dataset and each of the plurality of reference datasets based on the first set of characteristics and a second set of characteristics associated with the inference dataset; and
outputting at least one second indication of the respective level of similarity between the inference dataset and each of the plurality of reference datasets.

30. (canceled)
